(19) United States
(12) Patent Application Publication
(10) Pub. No.: US 2005/0144594 A1
(43) Pub. Date: Jun. 30, 2005

(54) System providing centralized management of a plurality of nodes on a network

(75) Inventor: Takeshi Yamazaki, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/858,844

(22) Filed: Jun. 2, 2004

(30) Foreign Application Priority Data
Dec. 26, 2003 (JP) 2003-435597

(51) Int. Cl. G06F 9/45

(52) U.S. Cl. 717/136

(57) ABSTRACT

A system of a network comprising a router, first switch, firewall, second switch, load sharing unit, third switch, and server firmware is managed in an operation management integration node as an internal component of a virtual node. The operation management integration node enables a person in charge of operation to set each device in a common command format, and after converting the common format into the command for each device, the operation management integration node inputs said command to each device to set each device. Also, the operation management integration node checks the consistency of the definitions set for the common format.

### BACKGROUND OF THE INVENTION

1. Field of the Invention

The present invention relates to an operation management system for a plurality of nodes on a network.

2. Description of the Related Art

In the operation of a network system, it is possible to integrate and execute the design of setting parameters of a plurality of devices in one system. It has been necessary, however, to store parameter files used for each device in a medium such as a floppy disk (registered trademark), make a visit to each device and install the settings onto each device using said medium.

Thus, there has been a problem in that even if the setting of parameters is unitarily performed, some work through human labor was required for the setting of the parameters to all the devices, and each time any of the parameters are changed, it takes a lot of man hours and efforts to carry out said parameter-setting work (refer to patent document 1).

Furthermore, with regard to the setting consistency among the devices, a centralized management system is able to verify the setting consistency among the devices for the information that any system has in common such as IP address, MAC address and LAN information (speed, full duplex, half duplex), but with regard to the functions with which only special devices can be provided such as routing, bandwidth controlling and filtering, the centralized management system has no setting consistency among the devices, so that it is necessary to set these functions according to each device used (refer to patent document 2).

FIG. 1 is a flowchart showing the flow of the processes performed when the definition setting by a conventional system is reflected to each device.

First, in Step S10a, a user sets definitions for all the devices with an integrated operation management system as one definition. In Step S11a, the integrated operation management system confirms the contradiction of the definitions. In Step S12a, the user dissolves said one definition made with the integrated operation management system into the definitions for each device, and stores said definition in a medium such as a floppy disk (registered trademark). In Step S13a, the user moves to the place where each device is installed and logs in the definition to each device, and in Step S14a, the user has the definition read from the medium in which he stores the definition, such as a floppy disk (registered trademark) to the device that he has logged in, and instructs the device to reflect the definition. Then, the user performs the processes of Steps S13a and S14a for all the devices, and terminates the processing.

After some new systems were introduced, operation for actual use and operation for maintenance depended on the functions provided by each device, and it was necessary to carry out said operations directly with each device. In other words, it was necessary f or a person in charge of the operation of the new system to make a visit to each device to operate it or to connect the machine of the person in charge of the operation of the new system to each device by the LAN in use for operation management and connect the machine of said person to each device via the LAN from a remote place to operate each device.

In the case of the former instance, a considerably large amount of expenditure is required, such as the time and cost to be spent for going to the place where the device is installed, and the cost to be paid for the workers. In the case of the latter instance, there is a problem in that since operation can be performed from a remote place, the fragility of security may occur.
Patent document 1: Japanese patent application publication No. 6-110663
Patent document 2: Japanese patent application publication No. 7-210482

It is desired, therefore, that after parameter setting for a plurality of devices on a network is unitarily performed with one system, the person in charge of operation conducts the operation of one system (node for integrating operation management) installed in the place where a plurality of devices are installed from a remote place without distributing or reflecting the set parameter to each device individually, and a plurality of devices that are adjacent to this system are presumed to be an interface in said system by the person in charge of operation, thus concealing each device and making it unnecessary to set an individual parameter for each individual device and to perform operation for actual use and operation for maintenance for each individual device.

It is also desired that when it is necessary to automatically recognize each function that a plurality of devices that are integrated into a virtual node are based on the information of the devices and set a specific function between a plurality of devices, if a user sets the function, parameter setting is automatically performed for all the target devices having that function, and the verification of the consistency of set parameter contents is also automatically performed so as to improve the user's work for parameter setting and to prevent an error in parameter setting.

After the new system is introduced, it is also desired that for the sake of operation for actual use and operation for maintenance, the person in charge of operation accesses the operation management integration node located in a remote place and operates the virtual node so that said node provides to have operation for each device automatically performed in the virtual node, thereby integrating the target devices into one and accordingly reducing the cost for making a visit to the places where the devices are installed and for setting parameters to each device as well as minimizing the fragility of security owing to the integration of the targets for access.

### SUMMARY OF THE INVENTION

The object of present invention is to provide a system providing centralized management of a plurality of nodes on a network in which each network device can be set so as to have proper setting consistency without having to be set with the hands of the person in charge of operation later.

The system embodying the present invention is a management system that unitarily controls each device connected to a network, and comprises a communication unit communicating with each device and an operation management integration unit that has each device as an internal structure, has a virtual node having one command format, automatically converts the control contents designated to the virtual node by one command format into the format of each device and issues the control contents to each device via the communication unit.

In the present invention, each device that constitutes the network is managed as an internal component of the virtual node that the operation management integration unit has. Inputting of the control contents into the virtual node is implemented by one format, and after a format on the virtual node is converted into the format suitable for each device, the control contents are transmitted to each device using the communication unit to control each device. Consequently, the person in charge of operation does not need to be conscious of a command format peculiar to each device.

According to the present invention, each network device can be unitarily set and the consistency between different kinds of interfaces, etc. can be automatically set, thereby reducing the labor of the person in charge of operation to a great extent.

### BRIEF DESCRIPTION OF THE DRAWINGS

The present invention will be more apparent from the following detailed description when the accompanying drawings are referenced.

FIG. 1 is a flowchart showing the flow of the processes performed when the definition setting by a conventional system is reflected to each device.

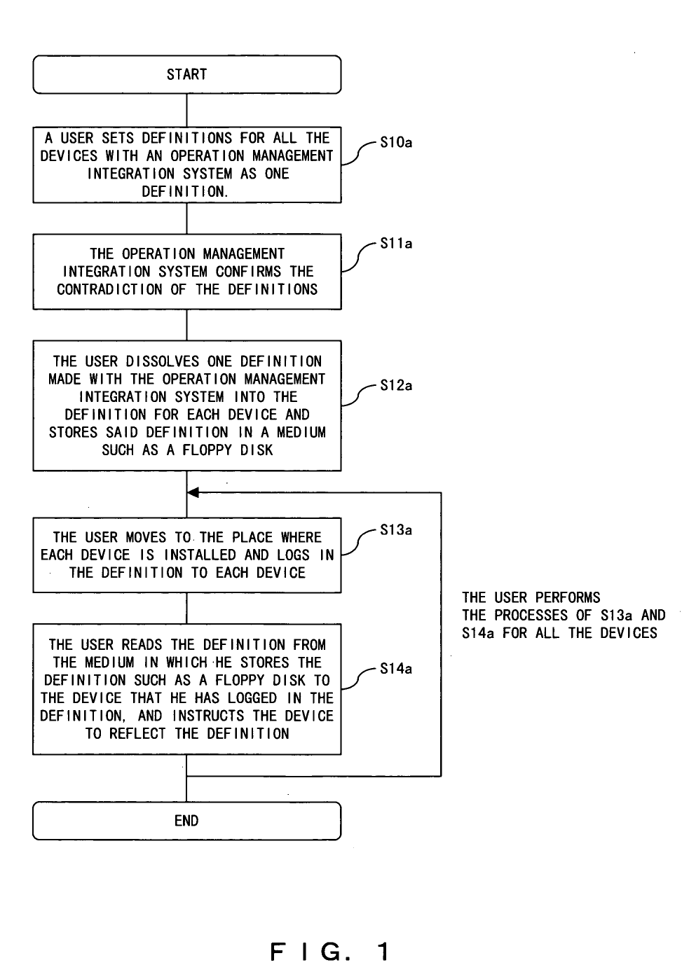

FIG. 2 shows an example of a virtual configuration of a plurality of nodes based on the embodiment of the present invention.

FIG. 3 shows the system configuration based on the embodiment of the present invention.

FIG. 4 shows the physical configuration viewed from the person in charge of operation.

FIG. 5 shows the configuration of the operation management integration node internal blocks (on the side of the network for business communication).

FIG. 6 shows the configuration of the operation management integration node internal blocks (on the side of the person in charge of operation).

FIG. 7 is a diagram (No.1) showing an internal table formed within the operation management integration node.

FIG. 8 is a diagram (No.2) showing an internal table formed within the operation management integration node.

FIG. 9 is a diagram (No.3) showing an internal table formed within the operation management integration node.

FIG. 10 is a diagram (No.4) showing an internal table formed within the operation management integration node.

FIGS. 11A and 11B are diagrams (No.5) showing internal tables formed within the operation management integration node.

FIGS. 12A and 12B are diagrams (No.6) showing internal tables formed within the operation management integration node.

FIG. 13 is a diagram (No.7) showing an internal table formed within the operation management integration node.

FIG. 14 is a diagram (No.8) showing an internal table formed within the operation management integration node.

FIG. 15 is a diagram (No.9) showing an internal table formed within the operation management integration node.

FIGS. 16A and 16B are diagrams (No.10) showing internal tables formed within the operation management integration node.

FIGS. 17A and 17B are diagrams (No.11) showing internal tables formed within the operation management integration node.

FIGS. 18A and 18B are diagrams (No.12) showing internal tables formed within the operation management integration node.

FIG. 19 is a diagram (No.13) showing an internal table formed within the operation management integration node.

FIG. 20 is a diagram (No.14) showing an internal table formed within the operation management integration node.

FIG. 21 is a diagram (No.15) showing an internal table formed within the operation management integration node.

FIG. 22 is a diagram (No.16) showing an internal table formed within the operation management integration node.

FIG. 23 is a diagram (No.17) showing an internal table formed within the operation management integration node.

FIG. 24 is a diagram (No.18) showing an internal table formed within the operation management integration node.

FIG. 25 is a flowchart showing the flow of pre-operations performed in a PC by the operation management integration node software (software for a PC).

FIG. 26 shows the flow of processes performed when the operation management integration node is introduced.

FIG. 27 shows the configuration of a real logic network and of interface and IP address in the virtual node.

FIG. 28 shows the configuration of a real logic network, interface and IP address in the virtual node viewed from the person in charge of operation.

FIG. 29 shows the relationship between a virtual node definition file and a definition file for each device.

FIG. 30 is a flowchart showing the outline of the flow of processes of reflecting definition setting based on the embodiment of the present invention.

FIG. 31 is a flowchart (No. 1) showing the details of the flow of processes of reflecting definition setting based on the embodiment of the present invention.

FIG. 32 is a flowchart (No. 2) showing the details of the flow of processes of reflecting definition setting based on the embodiment of the present invention.

FIG. 33 is a flowchart showing the flow of the processes of verifying the function unit consistency.

FIG. 34 is a flowchart (No. 1) showing the flow of the processes of dissolving reading-in commands into a temporary file for each function.

FIG. 35 is a flowchart (No. 2) showing the flow of the processes of dissolving reading-in commands into a temporary file for each function.

FIG. 36 shows an example of the actual-use operation of the virtual node.

FIG. 37 is a flowchart (No. 1) showing the flow of the processes of referring information to the virtual node.

FIG. 38 is a flowchart (No. 2) showing the flow of the processes of referring information to the virtual node.

FIG. 39 is a flowchart (No. 1) showing the flow of the processes of integrating command output.

FIG. 40 is a flowchart (No. 2) showing the flow of the processes of integrating command output.

### DESCRIPTION OF THE PREFERRED EMBODIMENTS

The embodiment of the present invention addresses to simultaneously accomplish both processes of:
holding various kinds of functions that each device has as the common information in the virtual node and focusing the object of operation by the person in charge of operation only on the virtual node; and
managing the logic network in terms of a network image consisting of conventional devices (in this case, each device is treated as a “component” in the virtual node, thus making unnecessary to operate each one as an independent one).

The following are realized in the embodiment of the present invention.
(1) Use of the operation management integration node makes it unnecessary for the person in charge of operation to directly perform a manual operation of a plurality of network devices other than simply to perform the operation of the virtual node. Instead, a function for converting information into the information peculiar to each device and relaying the information is realized for each device inside of the operation management integration node.
(2) The matching of the request to the virtual node from outside to the request to each device in the virtual node is realized using a table for matching a list of interfaces for each device to a list of interfaces for the virtual node.
(3) A mechanism for converting and distributing the definition for the virtual node to the definition for each device is realized using a table for matching the definition setting method for each device and with the definition setting method in the virtual node.
(4) A function for converting the operation for the virtual node into the operation for each device is realized while maintaining the matching of the function of operating each device to the function of operation in the virtual node.
(5) A mechanism is realized for confirming the consistency by combining the information that manages the functions that each device has, the contents whose consistency should be confirmed for each function, and the information about the functions that the configuration definition command realizes.

Described below are the details of the embodiment of the present invention with reference to the drawings.

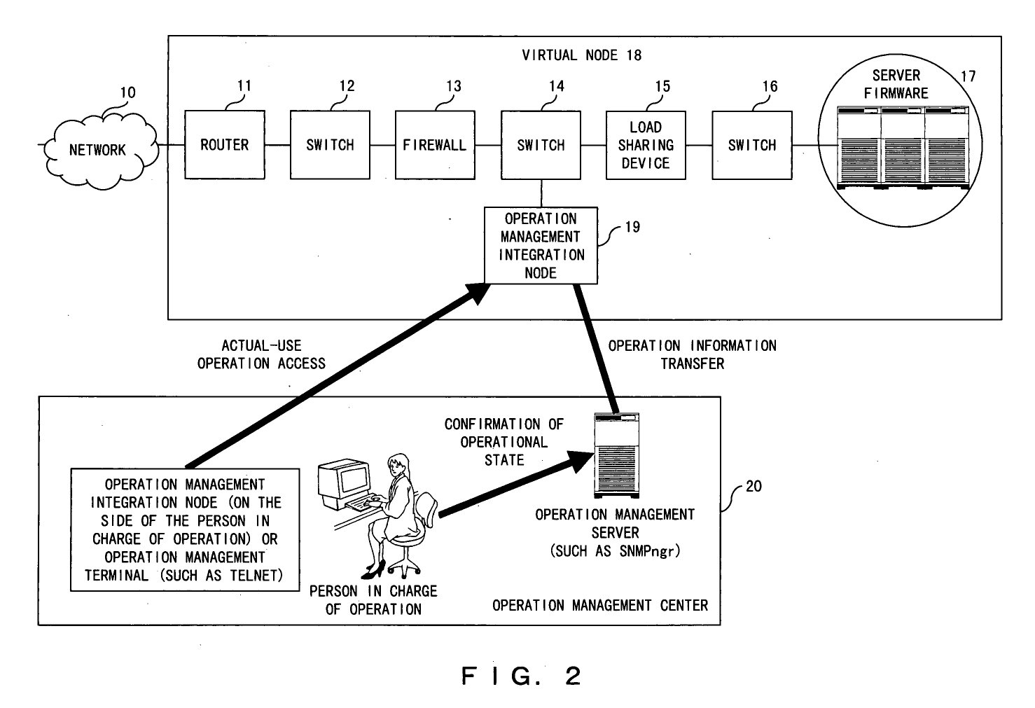

FIG. 2 shows an example of a virtual composition of a plurality of nodes based on the embodiment of the present invention. This drawing shows an image about an actual configuration in the embodiment of the present invention and an image as to how the actual configuration is viewed from the person in charge of operation. A router 11 is connected to a network 10, and subsequently a switch 12, a firewall 13, a switch 14, a load sharing device 15, a switch 16, a server firmware 17 are connected to the network 10. Information, etc. on the node in such a network configuration is managed in an operation management integration node 19 as the internal data of a virtual node 18. The operation management integration node 19 is connected to the switch 14. The person in charge of operation of an operation management center 20 operates data of the virtual node using an operation management terminal or operating the operation management integration node 19 directly, and reflects the setting of the data to each node. The operation management server in the operation management center 20 receives operation information from the operation management integration node 19, and indicates the operation information to the person in charge of operation.

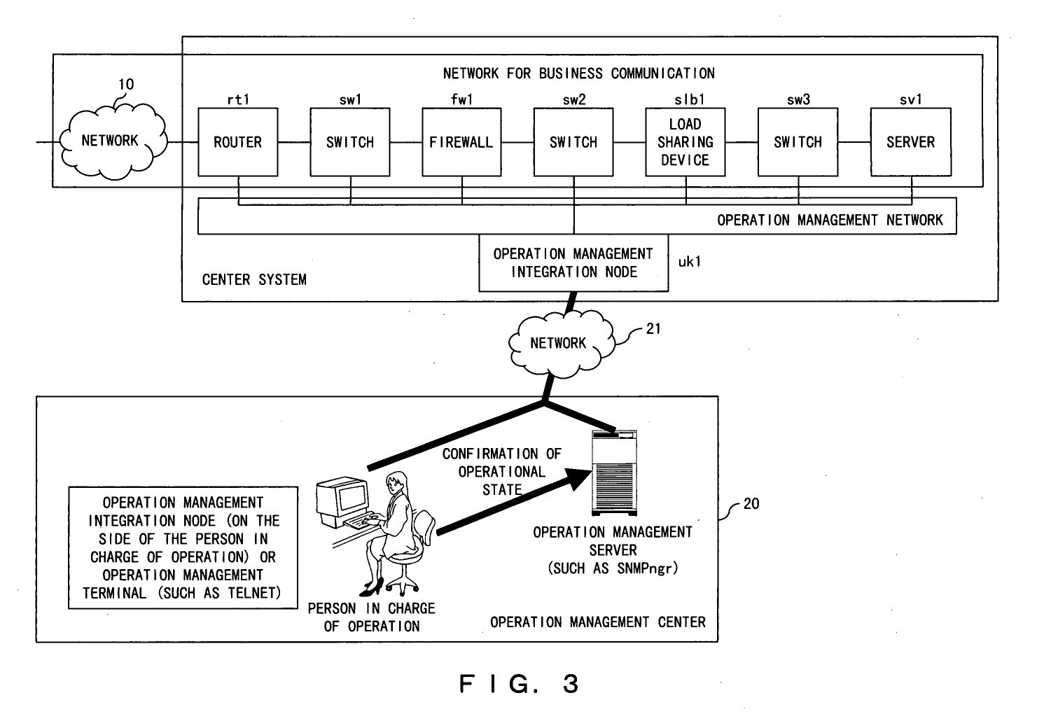

FIG. 3 shows the system configuration based on the embodiment of the present invention. A router rt1, a switch sw1, a firewall fw1, a switch sw2, a load sharing device slb1, a switch sw3 and a server sv1 are connected to the network 10 as a network for business communication. Also, an operation management integration node uk1 is connected to these devices by an operation management dedicated network. Also, an operation management center is connected to the operation management integration node uk1 via a network 21.

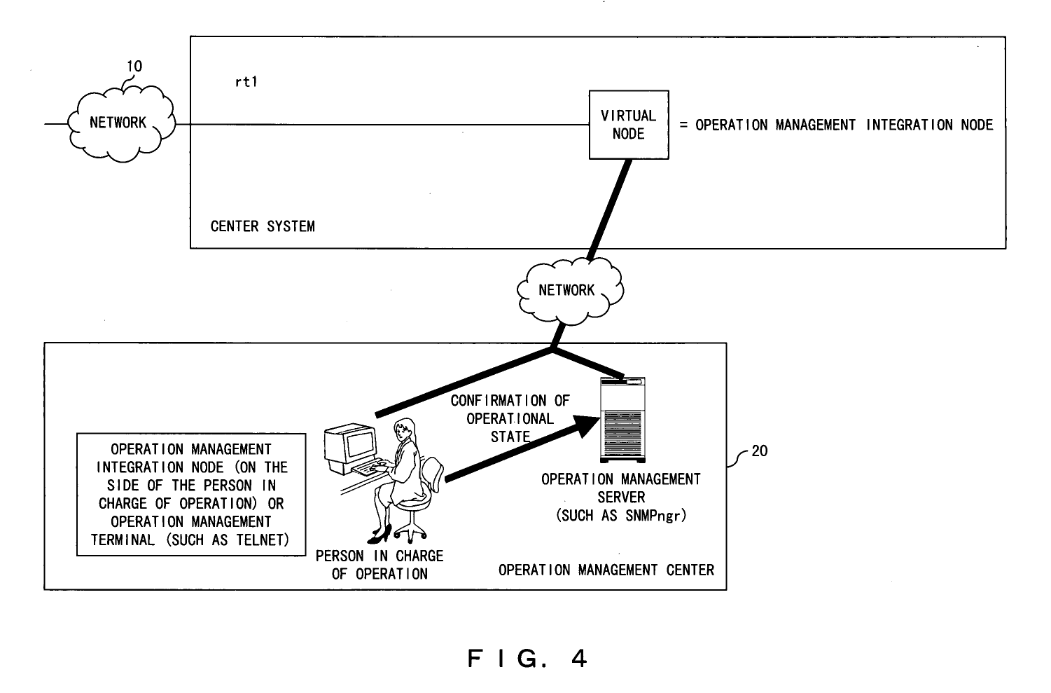

FIG. 4 shows the physical configuration viewed from the person in charge of operation. This figure shows an image of the system that the person in charge of operation operates and accesses to operate the system. In FIG. 2, it was mentioned that the person in charge of operation could see information of the network system via the operation management integration node. In that case, all necessary information of the network system is retained in the virtual node that is retained in the operation management integration node, and the person in charge of operation sees the set information, etc. of the network system as the information of the virtual node.

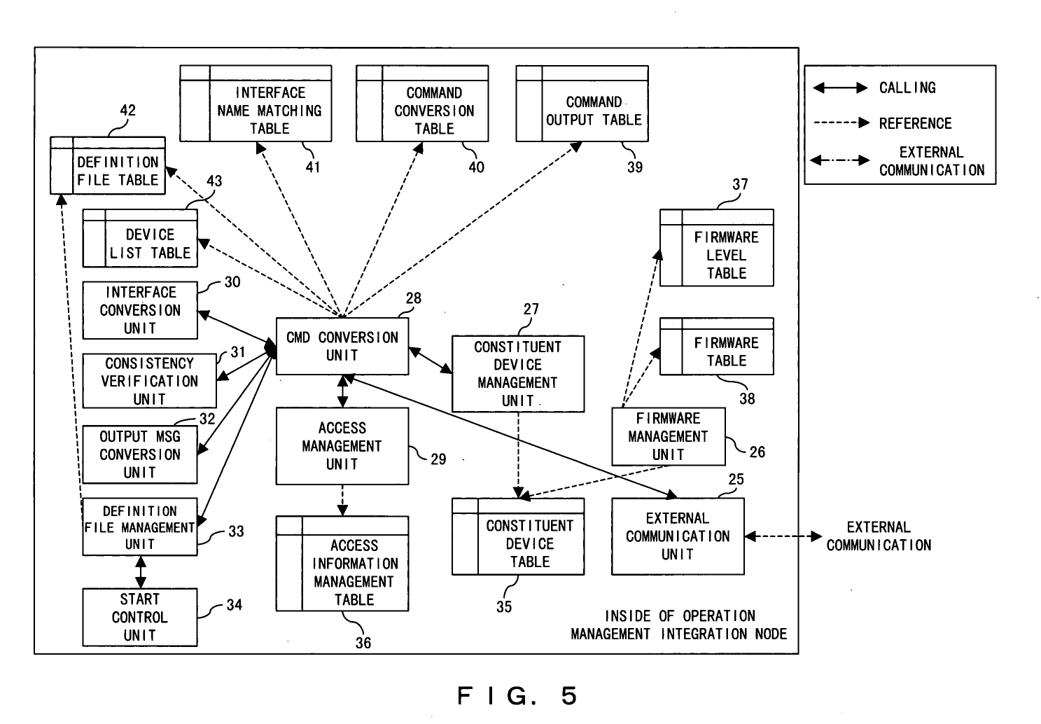

FIG. 5 shows the configuration of the operation management integration node internal blocks (on the side of the network for business communication). This figure is a block diagram showing the internal configuration of the operation management integration node to be installed in the virtual node shown in FIG. 2. In FIG. 5, an external communication processing unit 25 is a processing unit that performs communication with each node on the side of the network for business communication. A firmware management unit 26 is a processing unit that manages the firmware of each node constituting the network, and manages the information of a firmware level table 37 and a firmware table 38. A constituent device management unit 27 refers to a constituent device table 35 that is in a reference relationship with the firmware management unit 26 and manages the constituent devices in the network. A CMD conversion unit 28 is a processing unit that converts the definition information set on the virtual node into a command that can be set to each device. The CMD conversion unit 28 refers to a model list table 43, a definition file table 42, an interface name matching table 41, a command conversion table 40, and a command output table 39, and calls an access management unit 29. The access management unit 29 refers to an access information management table 36 and acquires the method of accessing the constituent devices in the network.

The CMD conversion unit 28 calls an interface conversion unit 30, a consistency verification unit 31, an output MSG conversion unit 32, and a definition file management unit 33. The interface conversion unit 30 converts an interface to make it possible to perform communication with the constituent devices in the network. The consistency verification unit 31 judges whether the set information defined in the definition file table 42 is so defined as to have proper consistency. The output MSG conversion unit 32 converts the format of a message. The definition file management unit 33 manages the set information of the constituent devices in the network that is set as the information of the virtual node by the person in charge of operation and the set information that is divided and converted to each device. A start control unit 34 performs the starting processing of the operation management node and each device in the network.

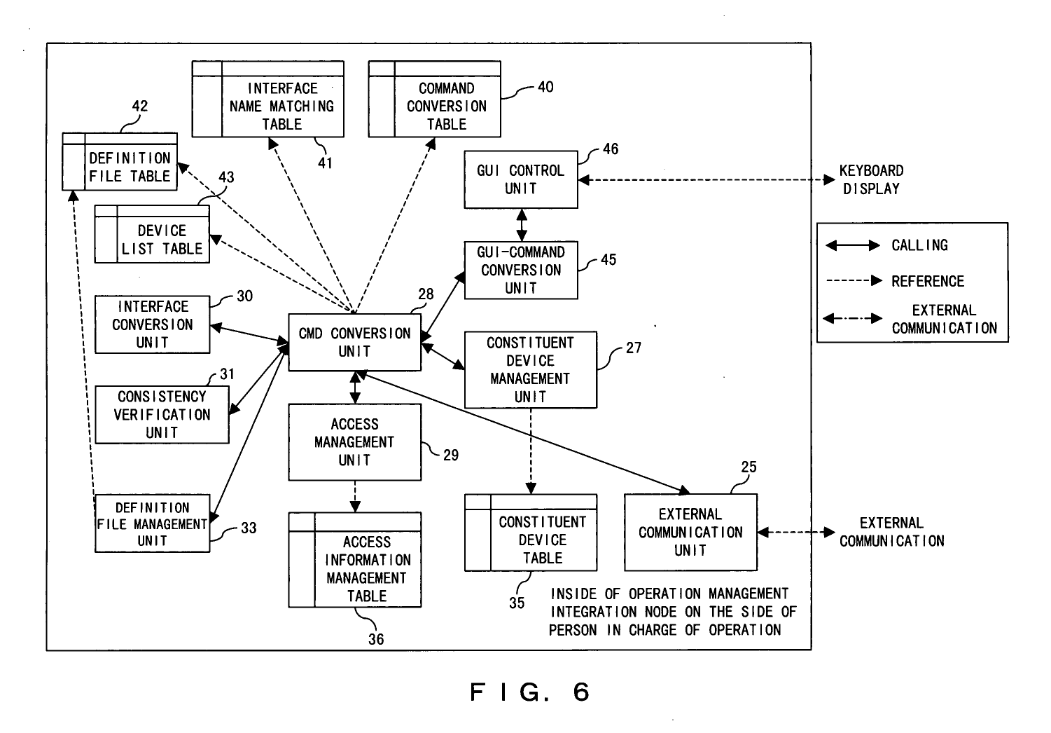

FIG. 6 shows the configuration of the operation management integration node internal blocks (on the side of the person in charge of operation). This figure is a block diagram showing the internal configuration of the operation management integration node that is installed as software on the terminal that the person in charge of operation shown in FIG. 2 uses. The same reference number is given to the same component shown in FIG. 5 to omit the detailed description of its function.

On the side of the person in charge of operation, in order to input instructions from the person in charge of operation or output information to the person in charge of operation, a GUI control unit 46 is connected to a keyboard or display so that necessary information can be exchanged between the GUI control unit 46 and the CMD conversion unit 28 via a GUI-command conversion unit 45.

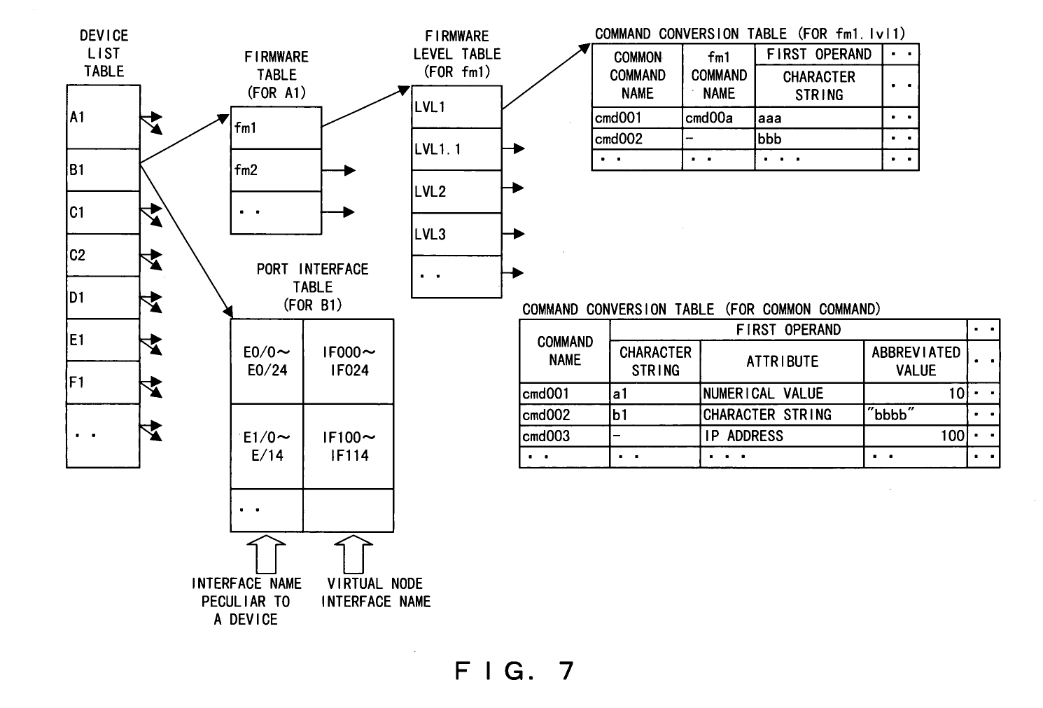

FIG. 7 to FIG. 24 are diagrams showing an internal table formed within the operation management integration node. FIG. 7 is a correlation diagram showing tables used in the embodiment of the present invention.

After a model of the constituent devices of the network is selected from the model list table, a port interface table in accord with the model is referred to, and the correlation of the interface name peculiar to the model and the virtual node interface name is obtained. On the other hand, a firmware table is referred to, and the firmware that the device of the model uses is identified. Then, a firmware level table is referred to, and the level of the firmware is obtained. After the level of the firmware is identified, a command conversion table in accord with the kind and level of the firmware is referred to. A command conversion table for common use is also provided and is used to convert definition information to the virtual node into the command for each device.

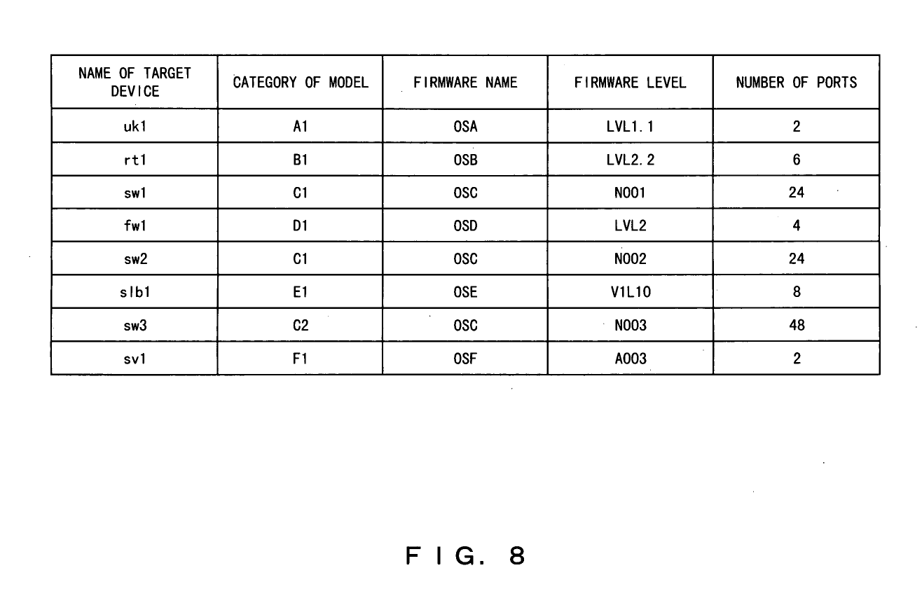

FIG. 8 is an example showing a table of network constituent devices. This is a table set by a user, in which name of target device, category of model, firmware name, firmware level, and number of ports are registered.

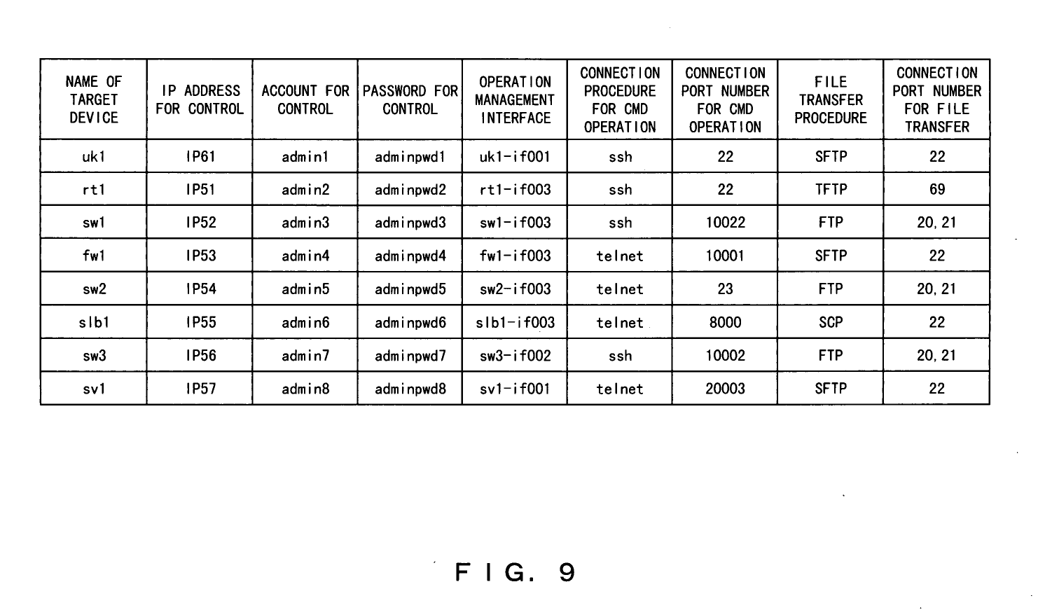

FIG. 9 is an example showing an access information management table that a user sets. IP address for control, account for control, password for control, operation management interface, CMD operation connection procedure, CMD operation connection port number, file transfer connection procedure, file transfer connection port number are stored in accord with the name of each target device. An IP address for control is the IP address used for communication to control the target device. Account and password for control are used to identify the person in charge of operation when he controls the target device. Operation management interface identifies the interface that is used for communication for operation management. CMD operation connection procedure and connection port designate the connection procedure and connection port that are used when a command is sent to the target device to operate the device. File transfer connection procedure and file transfer connection port number designate the connection procedure and connection port that are used when a file is transferred to the target device.

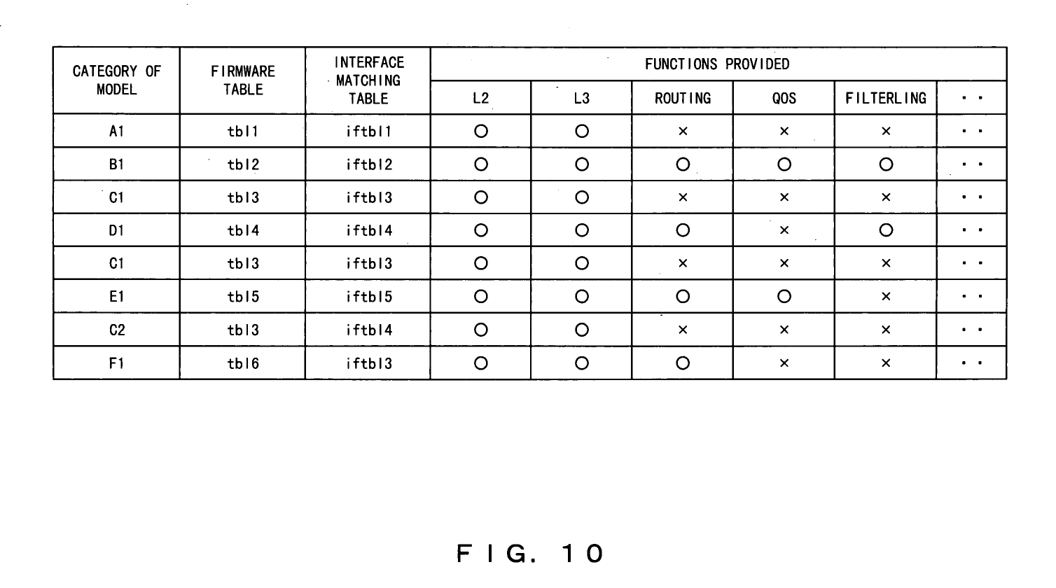

FIG. 10 is an example showing a model list table. Firmware table that registers the firmware that the model uses, interface correspondence table, and function provided are registered in accord with the category of the model. The firmware table indicates the name of the table that registers what firmware is used for a specific model. The interface correspondence table indicates the name of the table that shows the correlation of the interfaces used to transmit a command to the model. Function provided is the function that the model provides, and layer 2, layer 3, routing, QOS, and filtering are described in it. All the possible settings are known by this function provided.

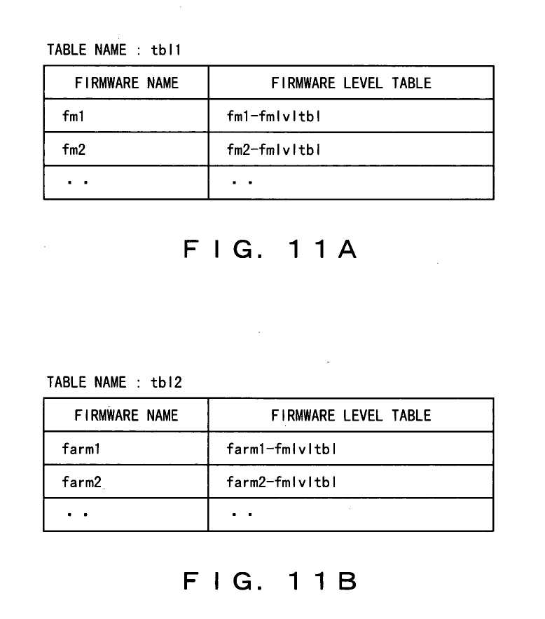

FIGS. 11A and 11B are examples showing a firmware table. FIG. 11A is an example of a firmware table with the name of tbl1, and the name of the firmware level table is registered in accord with the firmware name. FIG. 11B is similar to FIG. 11A. In the firmware table with name of tbl2, the firmware name is registered in accord with the name of the firmware level table.

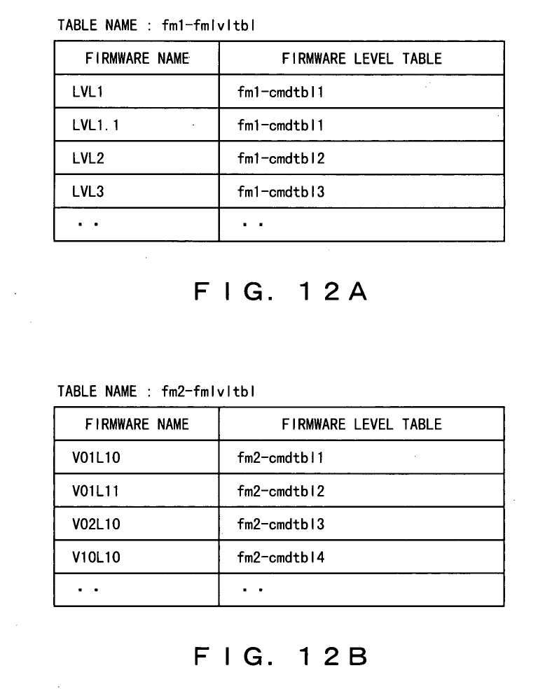

FIGS. 12A and 12B are examples showing a firmware level table. FIG. 12A is a firmware level table with the name of fm1-fmlvltbl. LVL1 is registered as the firmware level name in said table. FIG. 12B is a firmware level table with the name of fm2-fmlvltbl. VO1L10, etc. are registered as the firmware level names in said table, and the name of the command-by-model conversion table is also registered in accord with the firmware name.

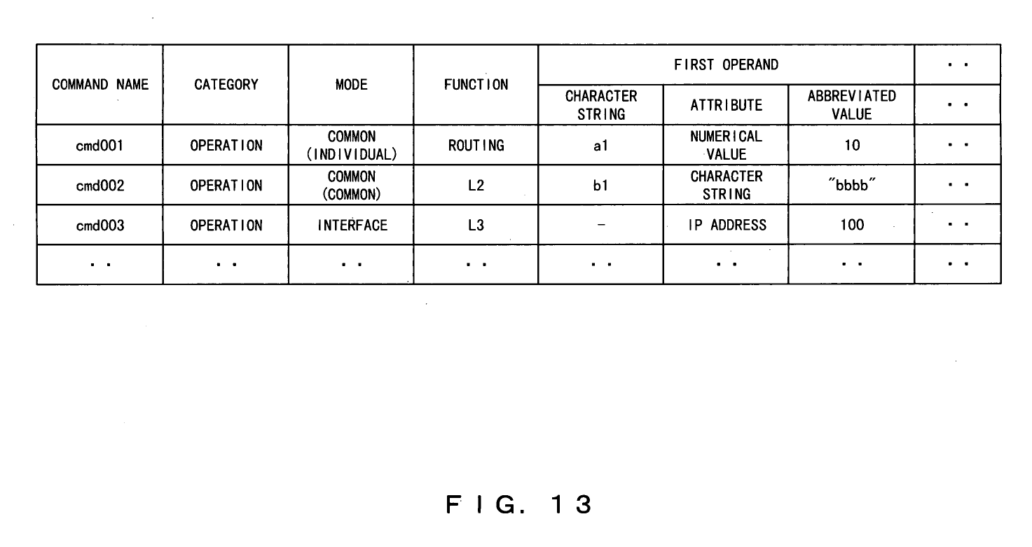

FIG. 13 is an example of a command conversion table that is used in common regardless of the firmware name. The table name is a common table. Command name is the name of a command that is transmitted to the virtual node from the person in charge of operation. Category is the control contents of a command. Mode describes whether this command regards all devices as the target, whether this command regards the device having a specific function as the target, or whether this command regards a specified interface as the target. Function describes whether the instruction contents of the command are routing, or are the control of layer 2 and layer 3. First operand describes the method of issuing an actual command.

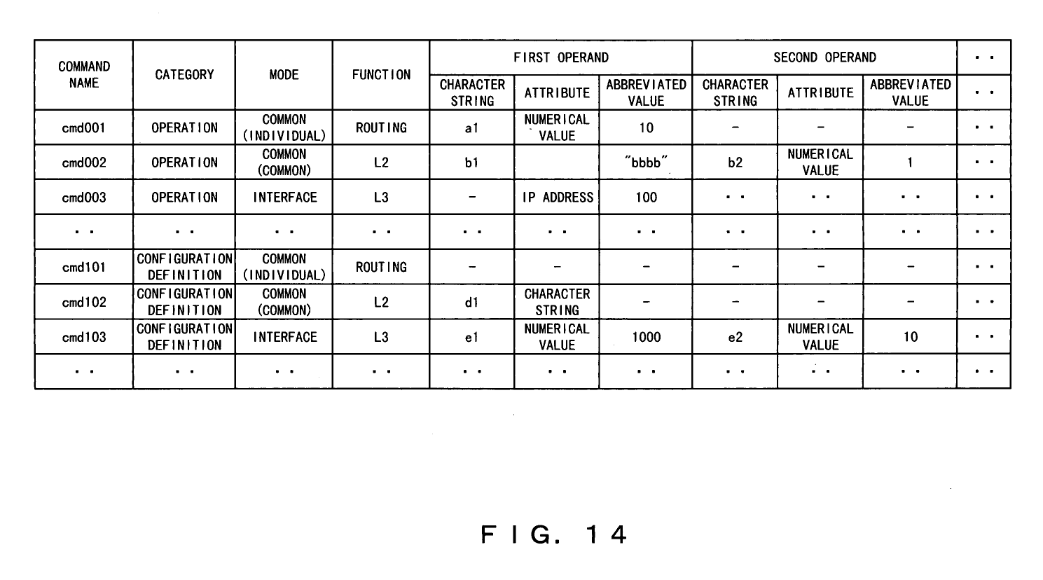

FIG. 14 is another example of a command conversion table that is used in common regardless of the firmware name. In the case of FIG. 14, as compared with FIG. 13, the description of second operand is added for each command. When a command takes a lot of operands, a necessary number of operands are described. In the category of command, an “operation” command that is temporarily inputted in an operational state and a “composition definition” command that is effective when the system is started up are indicated.

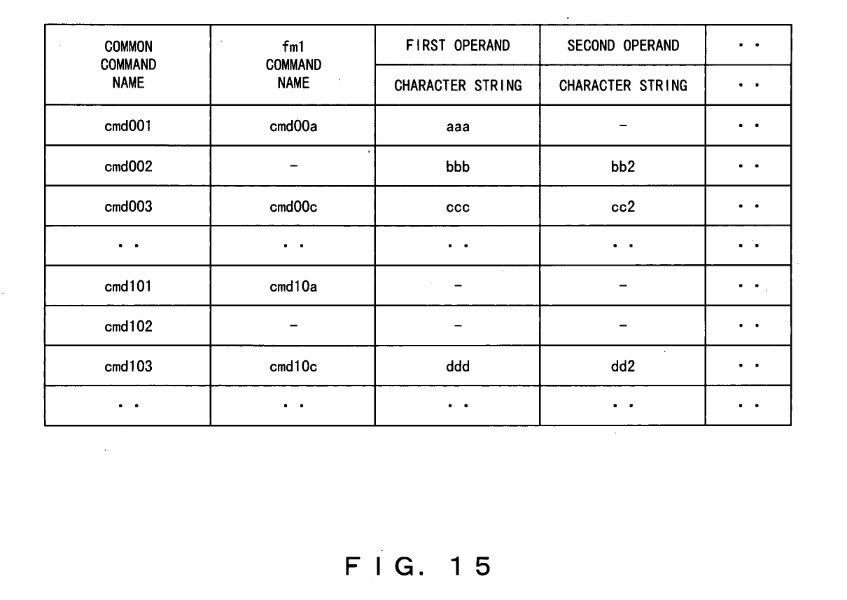

FIG. 15 is an example showing a command-by-firmware-name conversion table. The table name is fm1-cmdtbl1. Command name of fm1 is described in accord with the common command, and first operand and second operand are described.

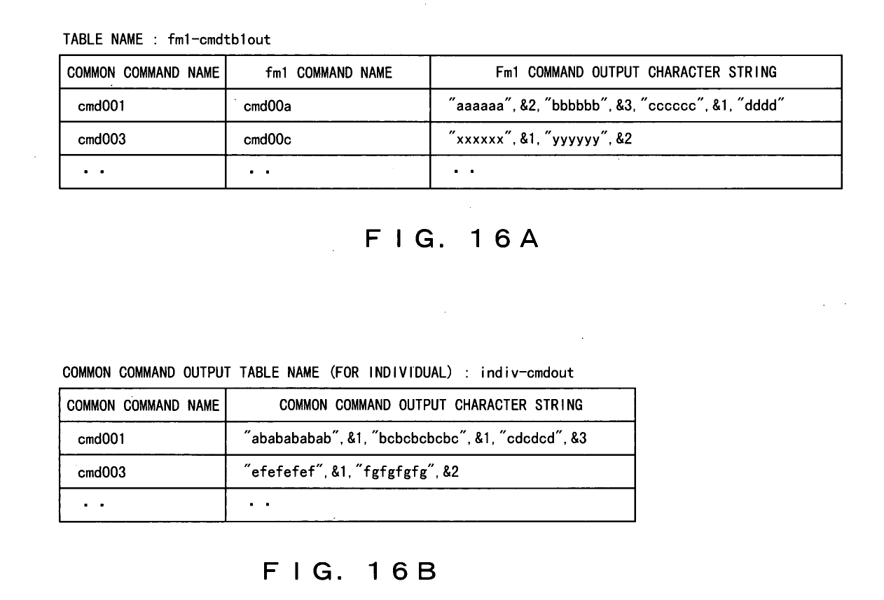

FIGS. 16A and 16B are examples showing a reference table used to make a compatible format for outputting a response message when a common command to the virtual node is issued only to one device.

FIG. 16A is a table in which a response message output pattern is registered when a firmware command with the name of fm1 is issued to the device in the table with name of fm1-cmdtbl1out. The correspondence to the common command is indicated in the table, and a format for matching a response message output character string of a command with the name of fm1 and the information to be extracted for unification as an argument is registered. At that time, for the method of outputting a response message as a common command, such a table as shown in FIG. 16B is provided. That is, a table in which common command name and character string of common command response output message are registered is provided.

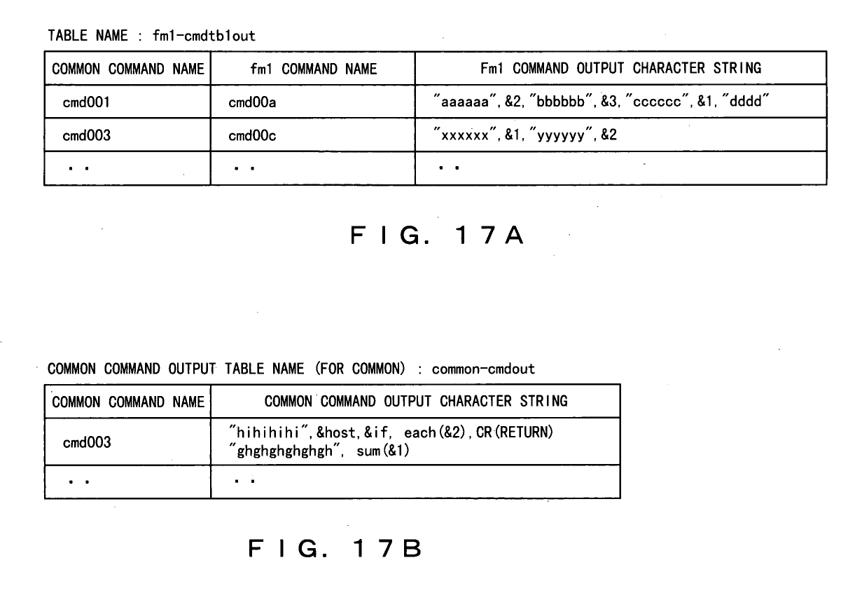

FIGS. 17A and 17B are examples showing a reference table used to make a compatible format for outputting a response message when a common command to the virtual node is issued to a plurality of devices. FIG. 17A is similar to FIG. 16A. Registered in the table shown in FIG. 17B are character string and response message output pattern that indicates how the information extracted from each device as an argument is processed and displayed as the format for a common command with the name of cmd003.

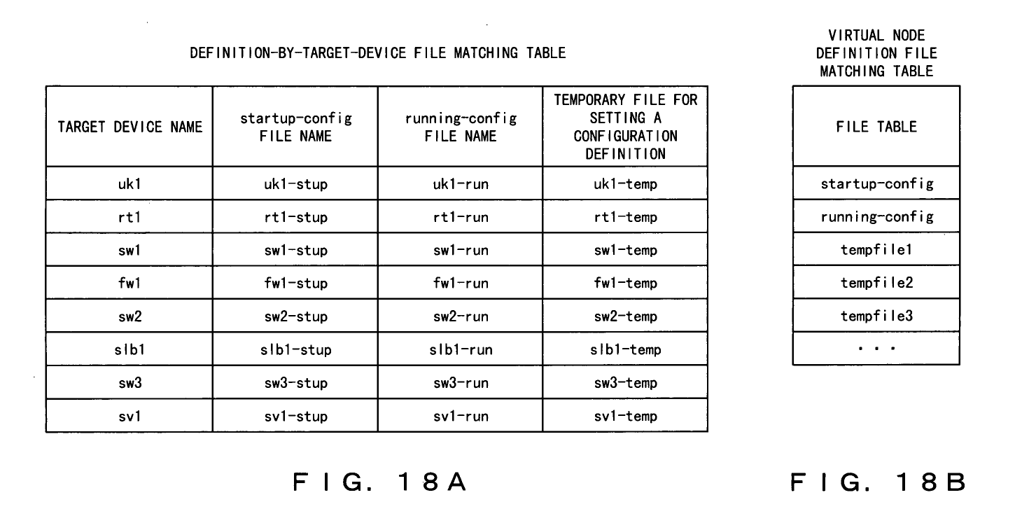

FIGS. 18A and 18B are examples showing a definition file table. FIG. 18A is a target device definition file matching table, and in this table, startup-config file name that prescribes the device configuration when the system is started up, running-config file name that prescribes the device configuration when the system is in operation, and name of a temporary file used when a configuration definition is changed are registered in accord with a target device. FIG. 18B is a virtual node definition file matching table, and files constituting a definition file of the virtual node are described in this table. Startup-config, running-config, tempfile1, tempfile2, tempfile3, etc. are registered as a file name.

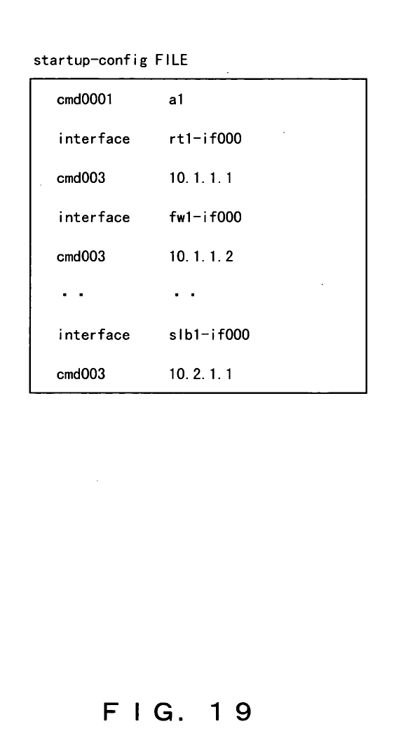

FIG. 19 is an example showing a definition file for the virtual node. An example of startup-config file is shown in FIG. 19. A command has been issued and an interface has been set.

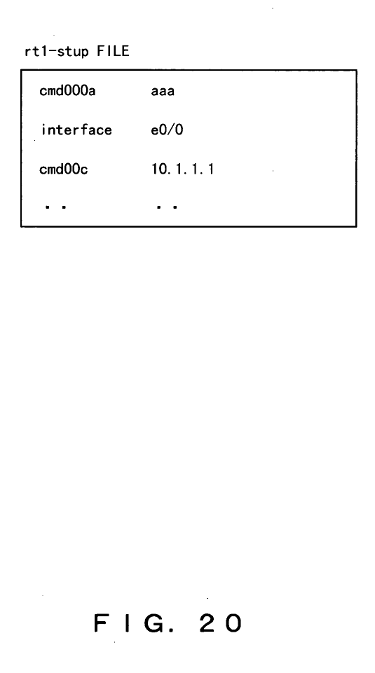

FIG. 20 is an example showing a definition file for routerrt1. The rt1-stup file is the file that defines the system configuration when the router rt1 is started, and only the part related to the router rt1 is described in terms of the specification of a command for the system based on the file shown in FIG. 19.

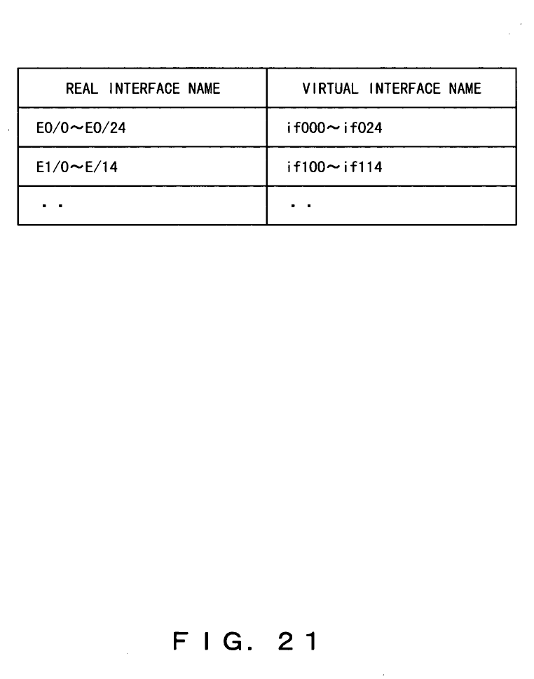

FIG. 21 is an example showing a port interface table. A real interface name is matched to a virtual interface name.

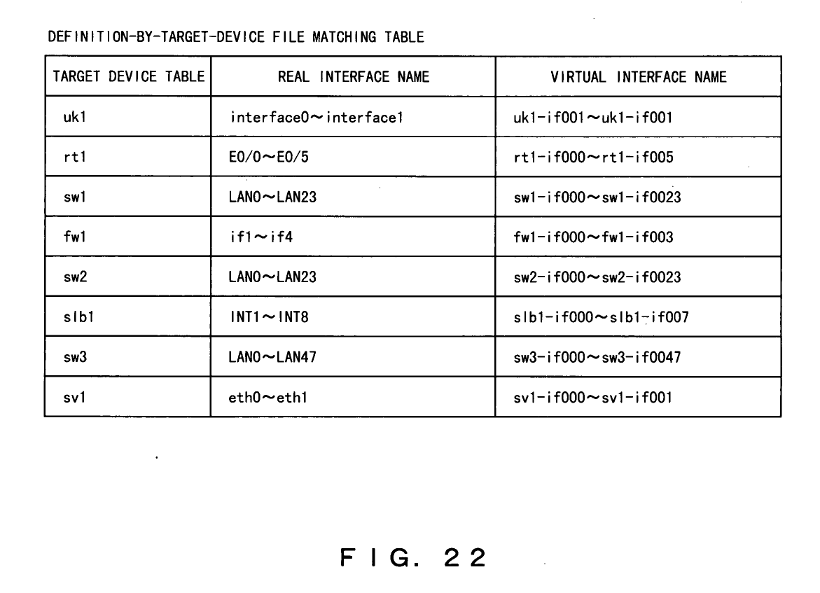

FIG. 22 is an example showing an interface neme matching table. Name of a target device, name of a real interface and name of a virtual interface are matched.

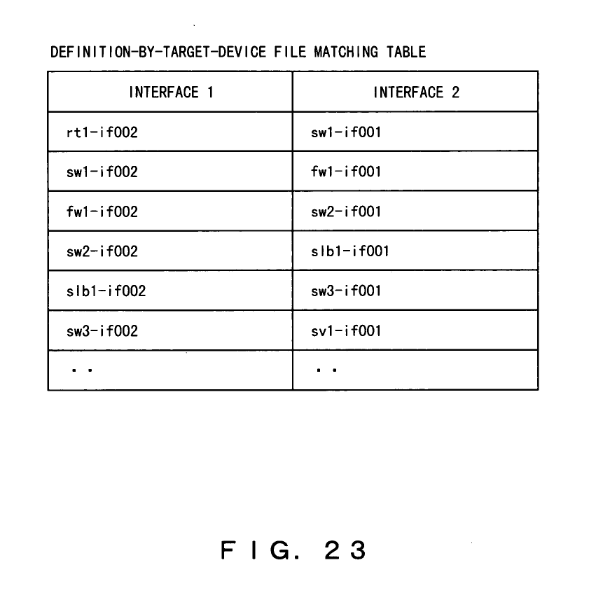

FIG. 23 is an example showing an interface link relationship matching table. This table shows the matching relations of the interfaces that are connected to each other, and interface 1 and interface 2 are connected in the virtual node. This connection relationship is matched to the connection relationship of the constituent devices of an actual network.

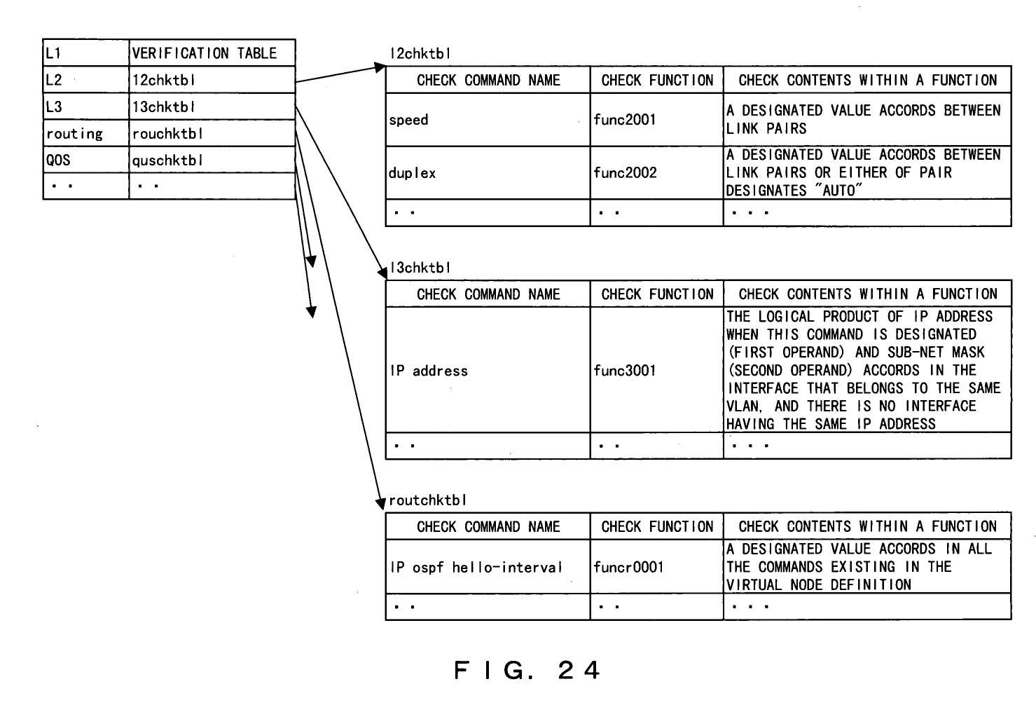

FIG. 24 is an example showing a function consistency verification table. A table registered in the verification table is referred to in accord with each function. Check command name, check function and contents of function are registered in accord with each other in the verification table, and the consistency of functions is verified using these check commands.

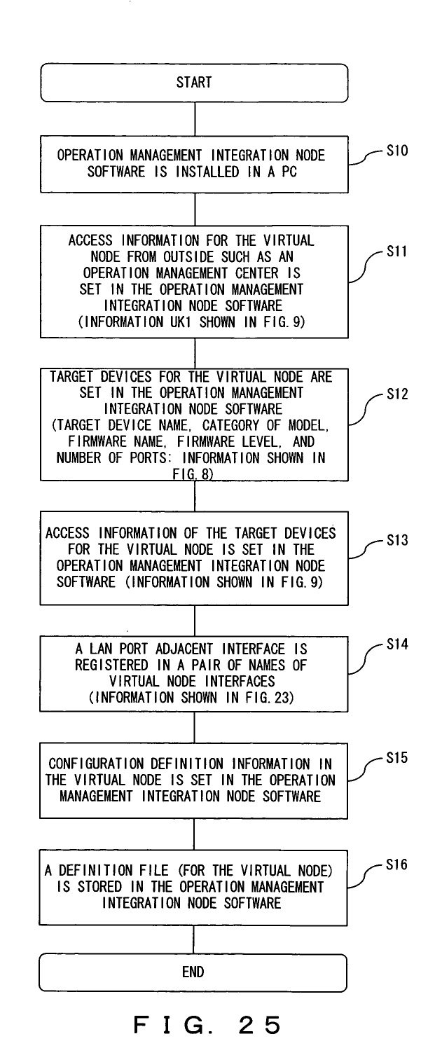

FIG. 25 is a flowchart showing the flow of pre-operations performed in a PC by the operation management integration node software (software for a PC). FIG. 25 shows the operations that can be performed in advance using the integrated node that is installed as software on the terminal that the person in charge of operation uses.

In Step S10, operation management integration node software is installed in a PC. In Step S11, access information for the virtual node from outside such as an operation management center is set in the operation management integration node software. That is, the information of uk1 shown in FIG. 8 is set. In Step S12, target devices for the virtual node are set in the operation management integration node software. That is, target device name, device category, firmware name, firmware level and number of ports that are information shown in FIG. 8 are set. In Step S13, access information of the target devices for the virtual node is set in the operation management integration node software. That is, the information shown in FIG. 9 is set. In Step S14, a LAN port adjacent interface is registered in a pair of names of virtual node interfaces. That is, the information shown in FIG. 23 is registered. In Step S15, configuration definition information in the virtual node is set in the operation management integration node software. In Step S16, a definition file (for the virtual node) is stored in the operation management integration node software. When the definition file (for the virtual node) is stored, an examination of the consistency of information set between each device is automatically implemented.

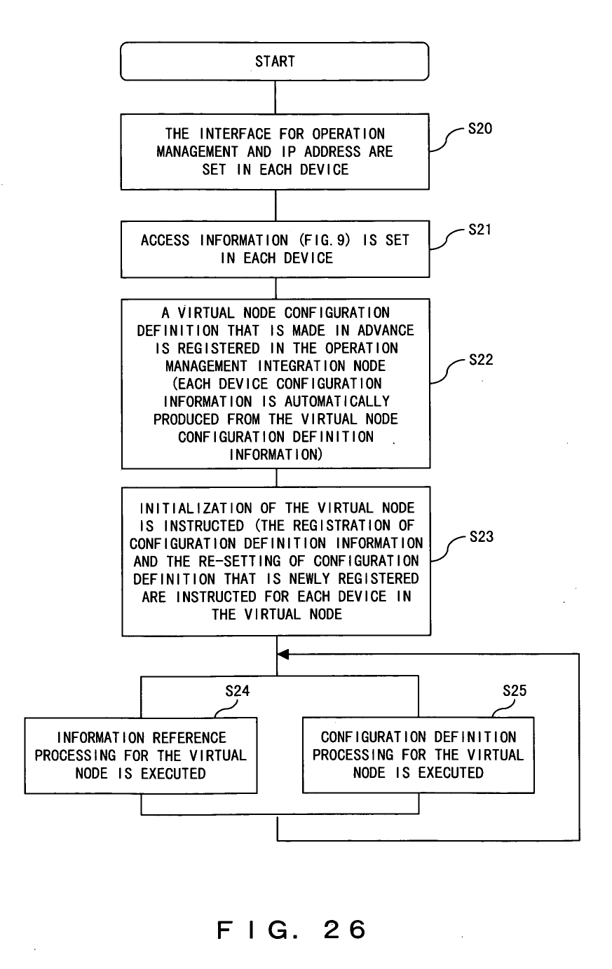

FIG. 26 shows the flow of processes performed when the operation management integration node is introduced. This figure shows the processes of operations that are performed when the operation management integration node and each device to be installed in the virtual node shown in FIG. 2 are introduced. In Step S20, the interface for operation management and IP address are set in each device. In Step S21, access information (FIG. 9) is set in each device. In Step S22, a virtual node configuration definition that is made in advance is registered in the operation management node. That is, each device configuration information is automatically produced from the virtual node configuration definition information. In Step S23, initialization of the virtual node is instructed. That is, the registration of configuration definition information and the re-starting by the configuration definition that is newly registered are instructed for each device in the virtual node. Step S24 and Step S25 are operations in an operational phase. In Step S24, information reference processing for the virtual node is executed, and in Step S25, configuration definition processing for the virtual node is executed. The processes of Step S22 and Step S23 are executed only when the operation management node is introduced, but are not executed in an operational phase. The processes of Step S20 and S21 are executed in each device in advance.

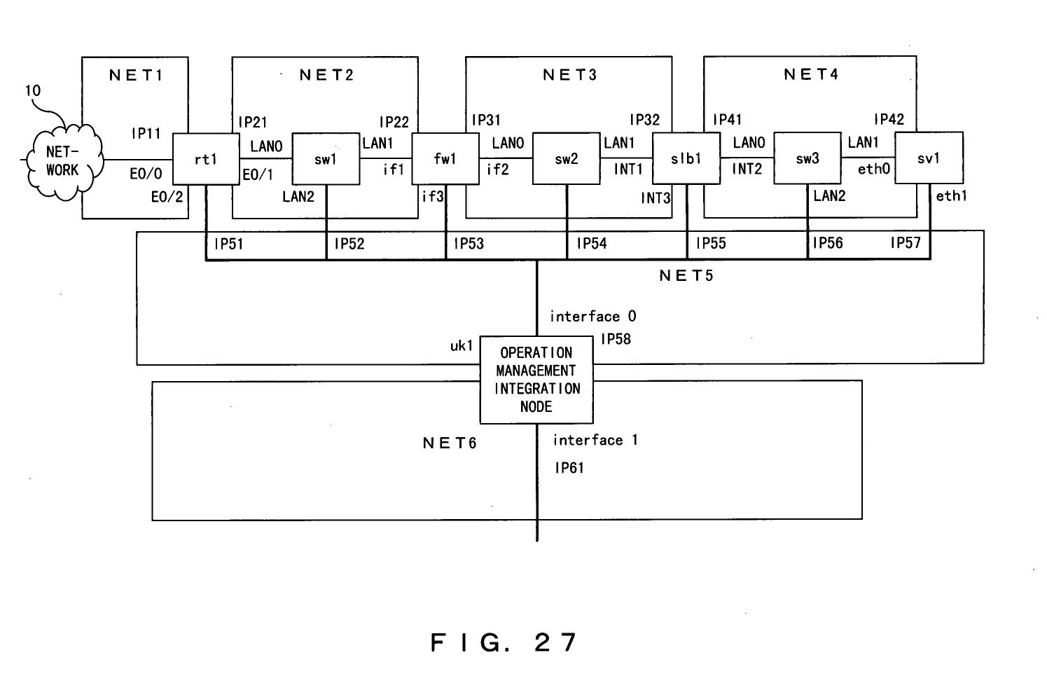

FIG. 27 shows the configuration of a real logic network and of interface and IP address in the virtual node. This figure is a block diagram showing a real-logic network, physical, IP address configuration in the virtual node.

Router rt1 connected to the network 10 is connected to the network 10 by logic network NET1. Router rt1, switch sw1 and firewall fw1 are connected by logic network NET2; firewall fw1, switch sw2 and load sharing device slb1 are connected by logic network NET3; load sharing device slb1, switch 3 and server 1 are connected by logic network NET4; these constituent devices in the network and operation management integration node uk1 are connected by logic network NET5; and operation management integration node uk1 and outside are connected by logic network NET6. IP address and interface are prescribed for each device.

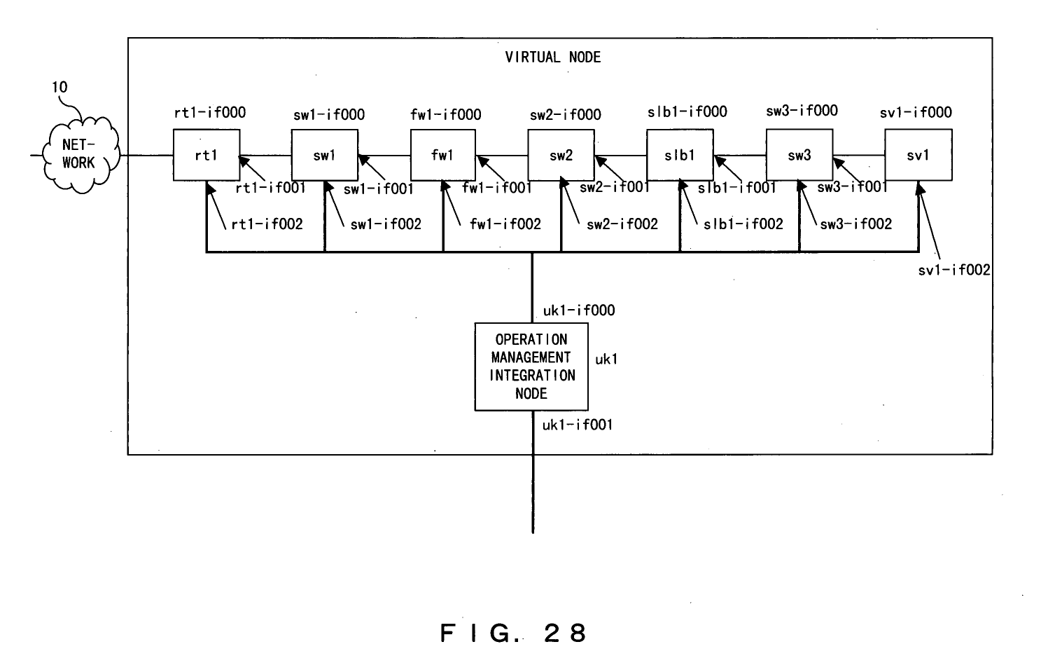

FIG. 28 shows the configuration of a real logic network, interface and IP address in the virtual node viewed from the person in charge of operation. This figure is a block diagram showing the configuration of the virtual node, physical, IP address configuration when said configuration is virtualized as a virtual node to the person in charge of operation. When the person in charge of operation views the configuration shown in FIG. 27 through the virtual node in the operation management integration node, each of the constituent devices in the network becomes an internal node in the virtual node, and a unique identifier is affixed to each port. These identifiers are completely matched to IP addresses shown in FIG. 27. Also, the interface that connects each internal node is the same on the virtual node. With regard to the connection of the parts that are connected by different interfaces shown in FIG. 27, an interface is automatically designated to carry out the connection when the virtual node actually sends a command to the constituent devices of the network, so the person in charge of operation does not need to worry about that.

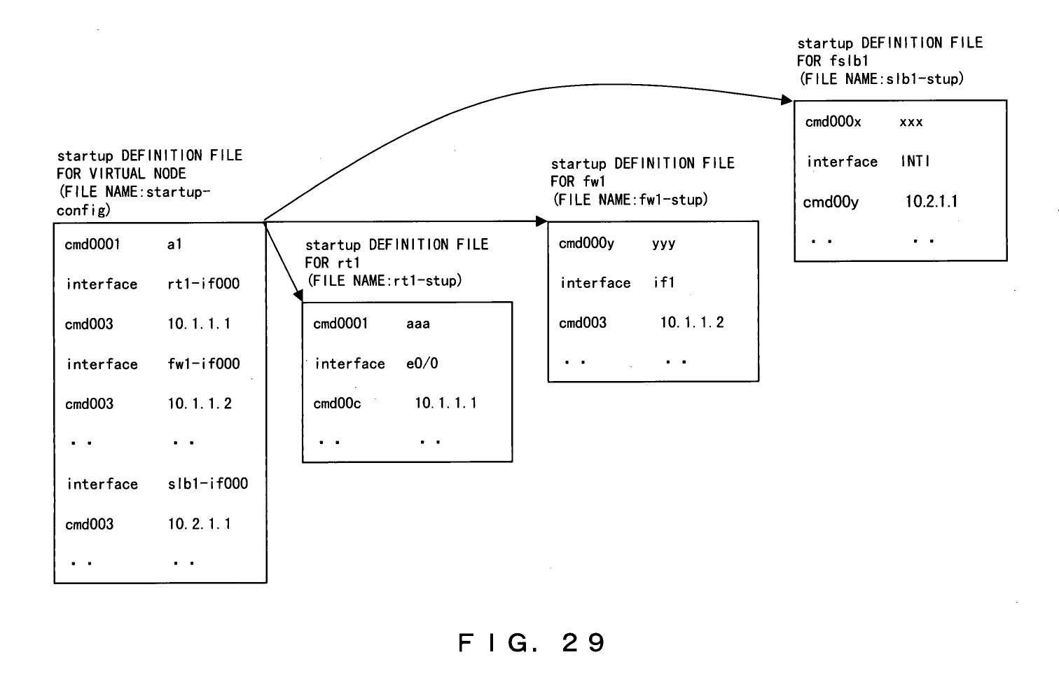

FIG. 29 shows the relationship between a virtual node definition file and a definition file for each device. This figure is a block diagram showing the relationship between the definition file that is managed as a virtual node and the definition file for each device that automatically generated in the operation management integration node.

The startup parameter file for the virtual node holds the contents that a user defines. The startup definition file for the router rt1 converts the common command and function that the router rt1 provides into the command for the router rt1 and holds the command. Also, the setting relative to the interface for the router rt1 is held in the name of the interface for the router rt1 and in terms of the specification of commands. The startup definition file for the firewall fw1 converts the common command and cmd0001 that is the function that the firewall fw1 provides into the command for the firewall fw1 and holds the command. Also, the setting relative to the interface for the firewall fw1 is held in the name of the interface for the firewall fw1 and in terms of the specification of commands. The startup definition file for the load sharing device slb1 converts the common command and cmd0001 that is the function that the load sharing device slb1 provides into the command for the load sharing device slb1 and holds the command. Also, the setting relative to the interface for the load sharing device slb1 is held in the name of the interface for the load sharing device slb1 and in terms of the specification of commands.

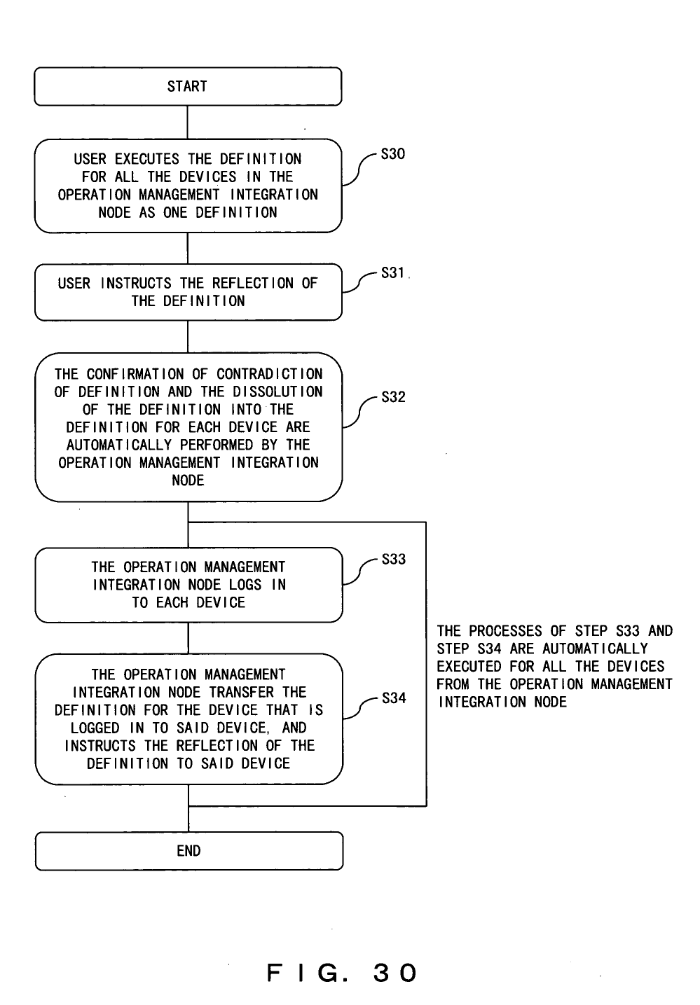

FIG. 30 is a flowchart showing the outline of the flow of processes of reflecting definition setting based on the embodiment of the present invention. First, in Step S30, the user executes the definitions for all the devices in the operation management integration node as one definition. In Step S31, the user instructs the reflection of the definition. In Step S32, the confirmation of the contradiction of definitions and the dissolution of the definition into the definition for each device are automatically performed by the operation management integration node. In Step S33, the operation management integration node logs in to each device, and in Step S34, the operation management integration node transfers the definition for the device that is logged in to said device, and instructs the reflection of the definition to said device. Then, the processes of Step S33 and Step S34 are automatically executed for all the devices from the operation management integration node.

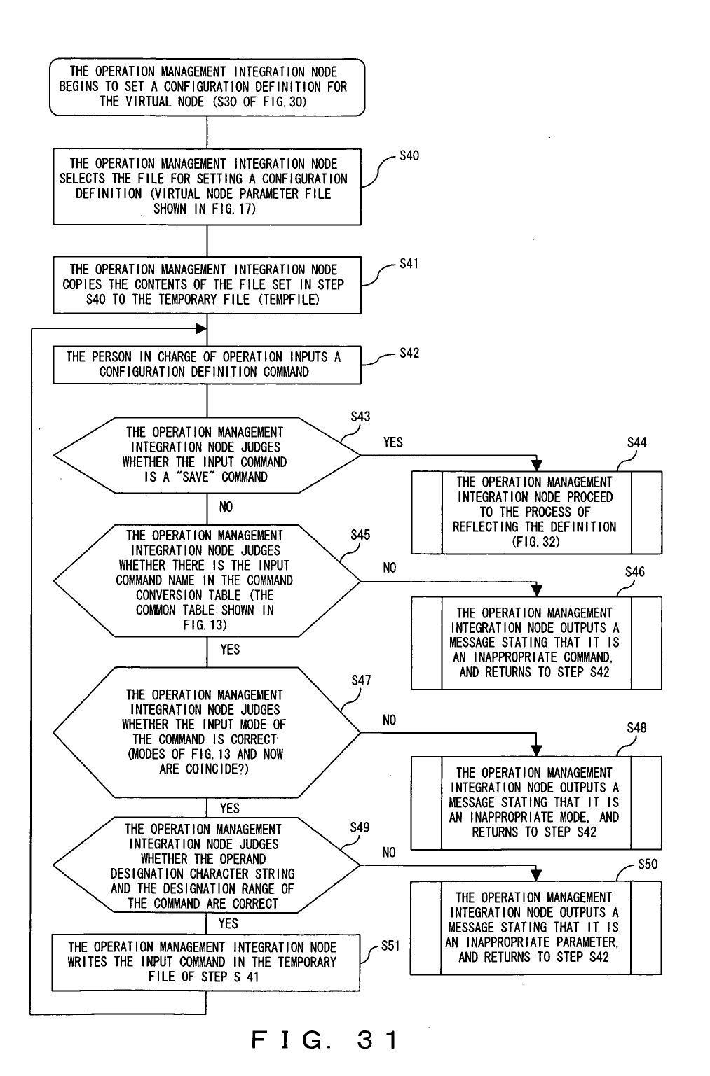

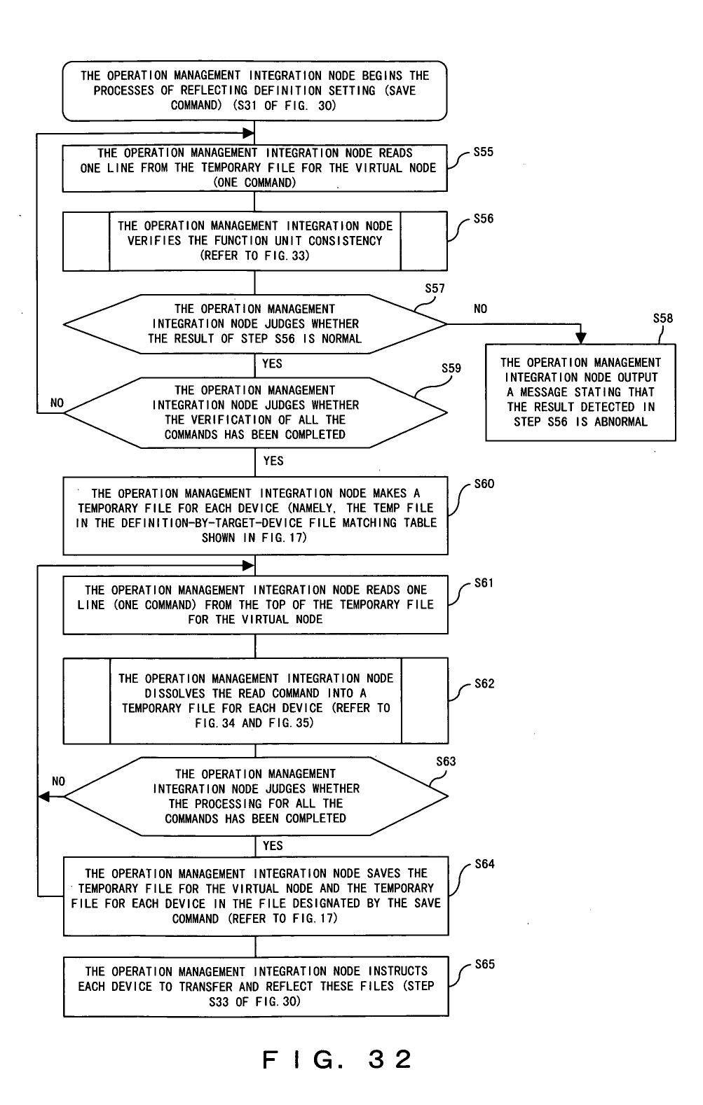

FIG. 31 and FIG. 32 are flowcharts showing the details of the flow of processes of reflecting definition setting based on the embodiment of the present invention. When receiving an instruction from the person in charge of operation, the operation management integration node operates. In Step S40 of FIG. 31, the operation management integration node selects the file for setting a configuration definition (virtual node definition file shown in FIG. 17). In Step S41, the operation management integration node copies the contents of the file designated in Step S40 to the temporary file (tempfile). In Step S42, the person in charge of operation inputs a configuration definition command. In Step S43, the operation management integration node judges whether the input command is a “save” command. If the judgement is YES in Step S43, in Step S44, the operation management integration node proceeds to the process of reflecting the definition shown in FIG. 32. If the judgement is NO in Step S43, in Step S45, the operation management integration node judges whether there is the input command name in the command conversion table (the common table shown in FIG. 13). If the judgement in Step S45 is NO, in Step S46, the operation management integration node indicates a message to the effect that it is an inappropriate command to the person in charge of operation, and the operation management integration node proceeds to Step S42. If the judgement in Step S45 is YES, in Step S47, the operation management integration node judges whether the input mode of the command is correct or not. That is, the operation management integration node judges whether the common table shown in FIG. 13 is in conformity with the present mode. If the judgement in Step S47 is NO, in Step S48, the operation management integration node indicates a message to the effect that it is an inappropriate mode to the person in charge of operation, and the operation management integration node returns to Step S42. If the judgement in Step S47 is YES, in Step S49, the operation management integration node judges whether the operand designation character string and designation range of the command are correct or not. If the judgement in Step S49 is NO, in Step S50, the operation management integration node indicates a message to the effect that it is an inappropriate parameter to the person in charge of operation, and the operation management integration node returns to Step S42. If the judgement in Step S49 is YES, in Step S51, the operation management integration node writes the input command in the temporary file of Step S41, and the operation management integration node returns to Step 42.

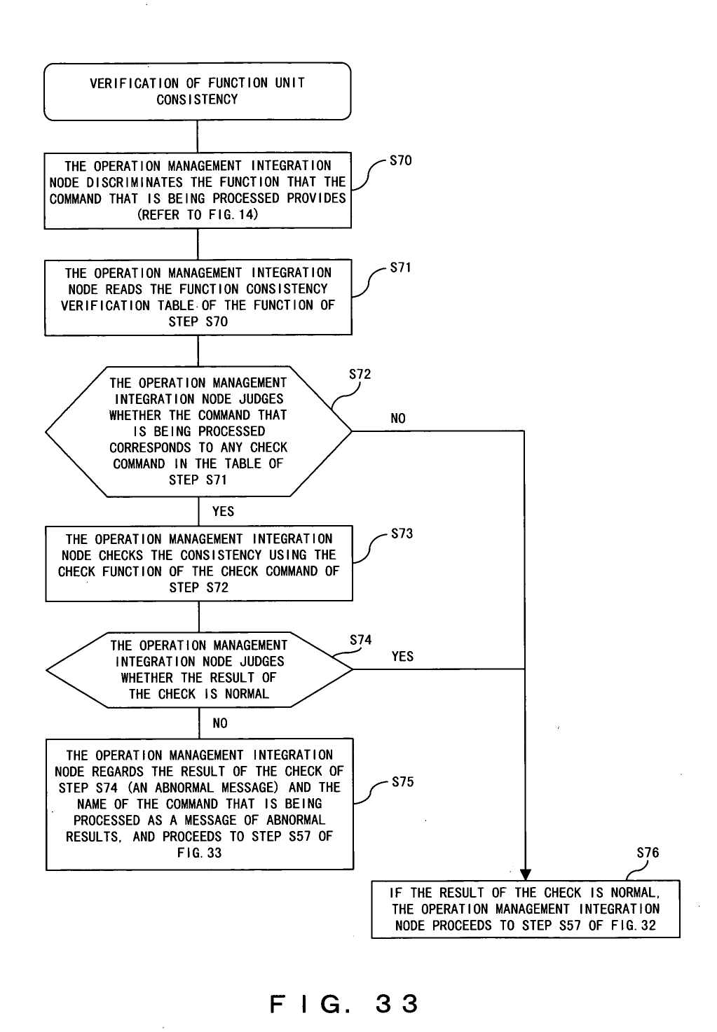

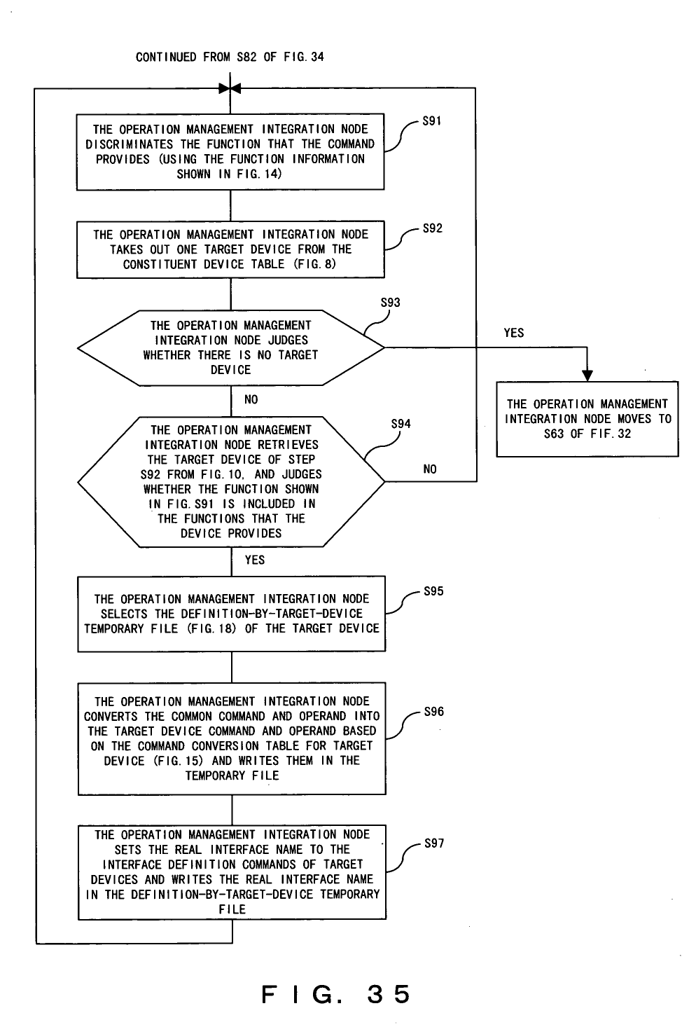

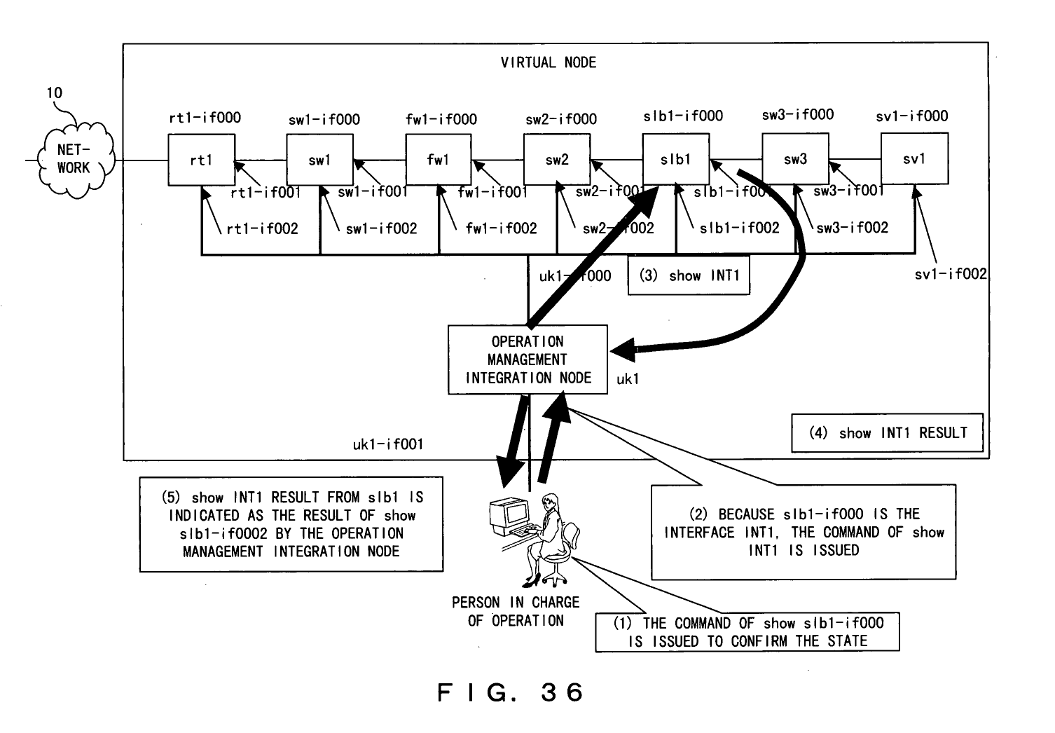

Furthermore, when receiving an instruction from the person in charge of operation, the operation management integration node operates. In Step S55 of FIG. 32, the operation management integration node reads one line (one command) from the temporary file for the virtual node, and in Step S56, the operation management integration node verifies the function unit consistency (refer to FIG. 33). In Step S57, the operation management integration node judges whether the result of Step S56 is normal or not, and if it is abnormal, in Step S58, the operation management integration node notifies a message to the effect that the result detected in Step S56 is abnormal to the person in charge of operation. If the judgement in Step S57 is YES, in Step S59, the operation management integration node judges whether the verification of all the commands has been completed. If the judgement in Step S59 is NO, the operation management integration node returns to Step S55. If the judgement in Step S59 is YES, in Step S60, the operation management integration node makes a temporary file for each device, namely the temp file shown in FIG. 17. In Step S61, the operation management integration node reads one line (one command) from the top of the temporary file for the virtual node. In Step S62, the operation management integration node dissolves the read command into a temporary file for each device (refer to FIG. 35 and FIG. 36). In Step S63, the operation management integration node judges whether the processing for all the commands has been completed. If the judgement in Step S63 is NO, the operation management integration node returns to Step S61. If the judgement in Step S63 is YES, in Step S64, the operation management integration node saves the temporary file for the virtual node and the temporary file for each device in the file designated by the save command (refer to FIG. 17). Then, in Step S65, the operation management integration node instructs each device to transfer and reflect these files. That is, the operation management integration node proceeds to Step S33 of FIG. 30.

FIG. 33 is a flowchart showing the flow of the processes of verifying the function unit consistency. In Step S70, the operation management integration node discriminates the function that the command that is being processed provides (using the table shown in FIG. 14). In Step S71, the operation management integration node reads the function consistency verification table of the function of Step S70. In Step S72, the operation management integration node judges whether the command that is being processed corresponds to any check command in the table of Step S71. If the judgement of Step S72 is NO, in Step S76, the result of the check is normal, and the operation management integration node proceeds to Step S57 of FIG. 32. If the judgement in Step S72 is YES, the operation management integration node checks the consistency using the check function of the check command of Step S72. In Step S74, the operation management integration node judges whether the result of the check is normal or not. If the judgement in Step S74 is YES, the operation management integration node proceeds to Step S76. If the judgement in Step S74 is NO, in Step S75, the operation management integration node regards the result of the check of Step S74 (an abnormal message) and the name of the command that is being processed as a massage of abnormal results and proceeds to Step S57 of FIG. 32.

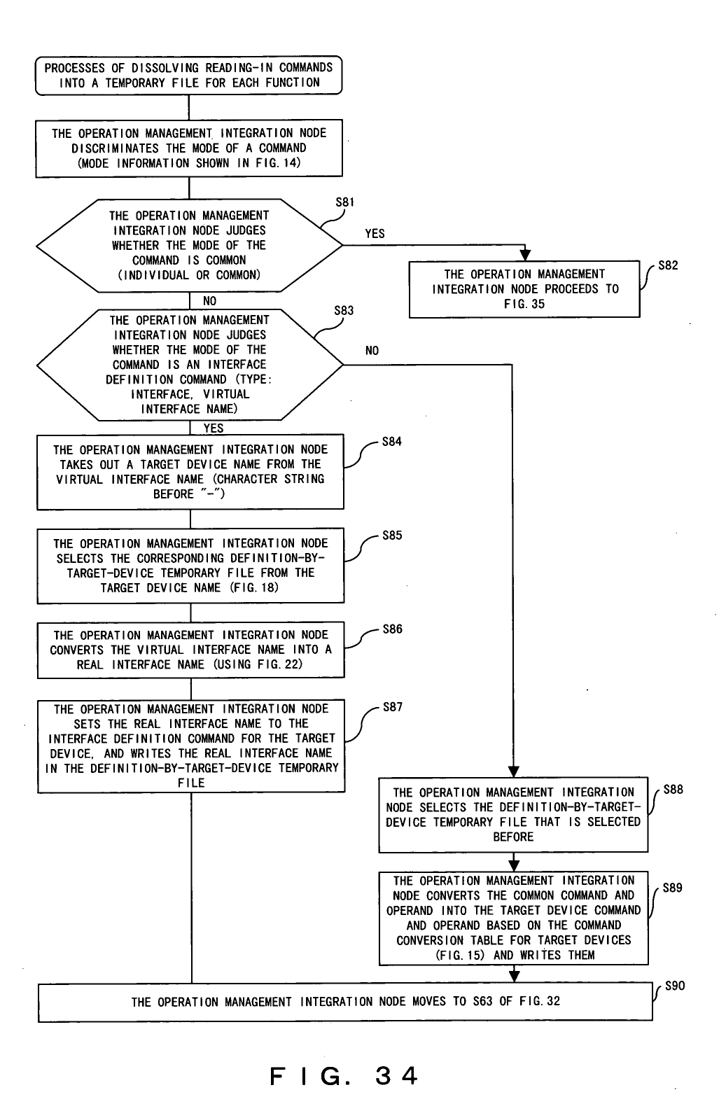

FIG. 34 and FIG. 35 are flowcharts showing the flow of the processes of dissolving reading-in commands into a temporary file for each function. In Step S80 of FIG. 34, the operation management integration node discriminates the mode of a command. That is, the operation management integration node compares the command based on the mode information shown in FIG. 14. In Step S81, the operation management integration node judges whether the mode of the command is common or not (individual or common). If the judgement in Step S81 is YES, in Step S82, the operation management integration node proceeds to FIG. 35. If the judgement in Step S81 is NO, in Step S83, the operation management integration node judges whether the mode of the command is an interface definition command. If the judgement in Step S83 is NO, the operation management integration node selects the definition-by-target-device temporary file, and in Step S89, it converts the common command and operand into the target device command and operand based on the command conversion table for target devices (FIG. 15) and writes them. Then, the operation management integration node proceeds to Step S90 and proceeds to Step S63 of FIG. 32. If the judgement in Step S83 is YES, in Step S84, the operation management integration node takes out a target device from the virtual interface name. In Step S85, the operation management integration node selects the corresponding definition-by-target-device temporary file from the target device name (refer to FIG. 18). In step S86, the operation management integration node converts the virtual interface name into a real interface name using FIG. 22. In Step S87, the operation management integration node sets the real interface name to the interface definition command for the target device, writes the real interface name in the definition-by-target-device temporary file, and proceeds to Step S90.

In Step S91 of FIG. 35, the operation management integration node discriminates the function that the command provides using the function information shown in FIG. 14. In Step S92, the operation management integration node takes out one target device from the constituent device table (FIG. 8). In Step S93, the operation management integration node judges whether there is any target device. If the judgement in Step S93 is YES, the operation management integration node proceeds to Step S63 of FIG. 32. If the judgement in Step S93 is NO, in Step S94, the operation management integration node retrieves the target device of Step S92 based on FIG. 10, and judges whether the function shown in FIG. S91 is included in the functions that the device provides. If the judgement in Step S94 is NO, the operation management integration node proceeds to Step S92. If the judgement in Step S94 is YES, in Step S95, the operation management integration node selects the definition-by-target-device temporary file (FIG. 18) of the target device, and in Step S96, the operation management integration node converts the common command and operand into the target device command and operand based on the command conversion table for target devices (FIG. 15) and writes them in the temporary file. Then, in Step S97, if the judgement in Step S93 is YES, the operation management integration node sets the real interface name to the interface definition commands of target devices, writes the real interface name in the definition-by-target-device temporary file, and returns to step S92.

FIG. 36 shows an example of the actual-use operation of the virtual node. This figure shows the state in which the operation management integration node inputs the actual-use operation command for the virtual node from the person in charge of operation into the device to which said command should be inputted, and outputs said command in the form of a common message of the virtual node.

According to FIG. 36, when the command of “show slb1-if000” to confirm the state is issued(1), since slb1-if000 is the interface INT1 of the load sharing device sib1, the command of “show INT1” is issued (2). This conversion is implemented by the operation management integration node. When this command is received by the load sharing device slb1 (3), the result is sent back to the operation management integration node (4). Then, the operation management integration node indicates the response result from the load sharing device slb1 to the person in charge of operation as the result of the command “show slb1-if000” (5).

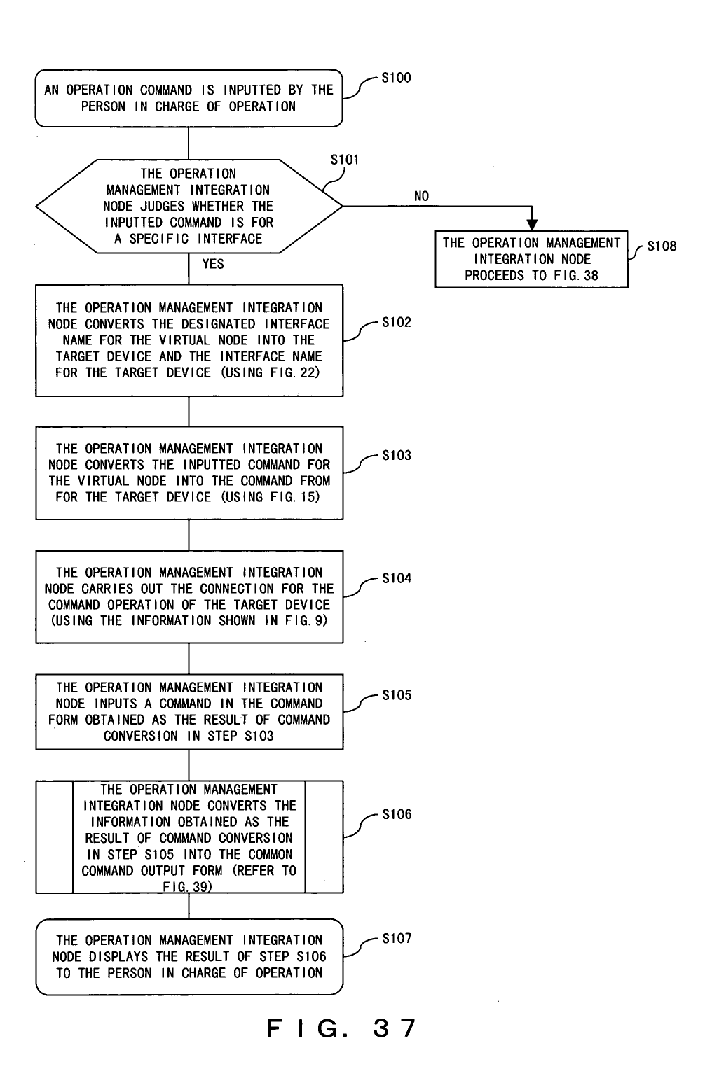

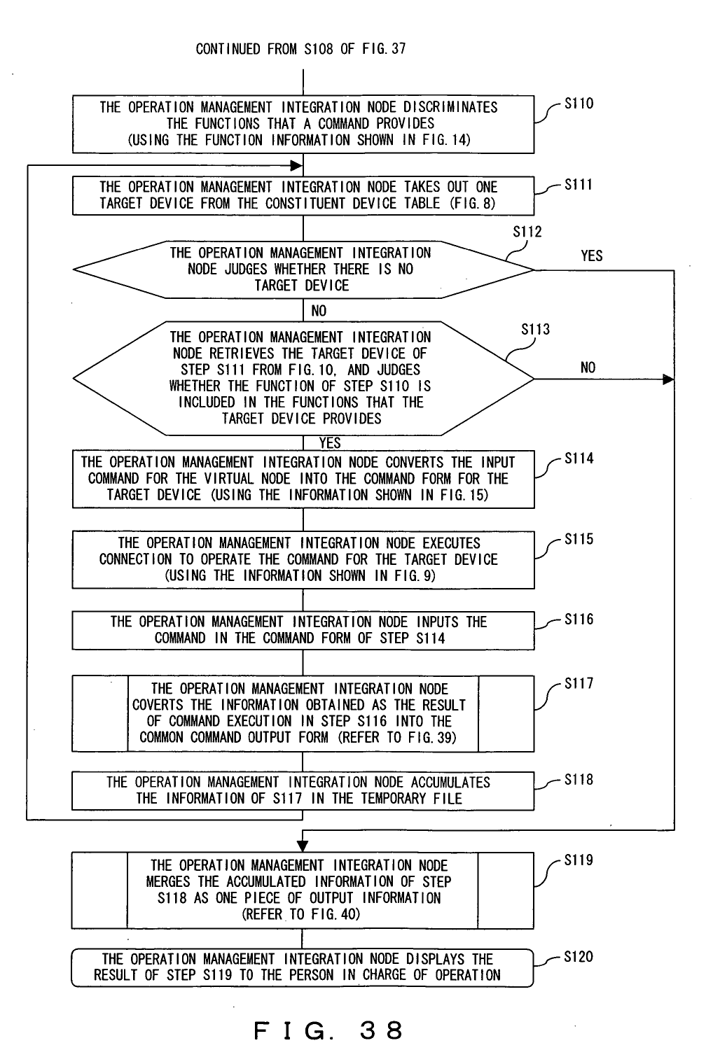

FIG. 37 and FIG. 38 are flowcharts showing the flow of the processes of referring information to the virtual node. These figures show the flow of processes, to be performed in the operation management integration node, in which the person in charge of operation inputs the actual-use operation command for the virtual node, and said command is outputted in the form of a common message in the virtual node.

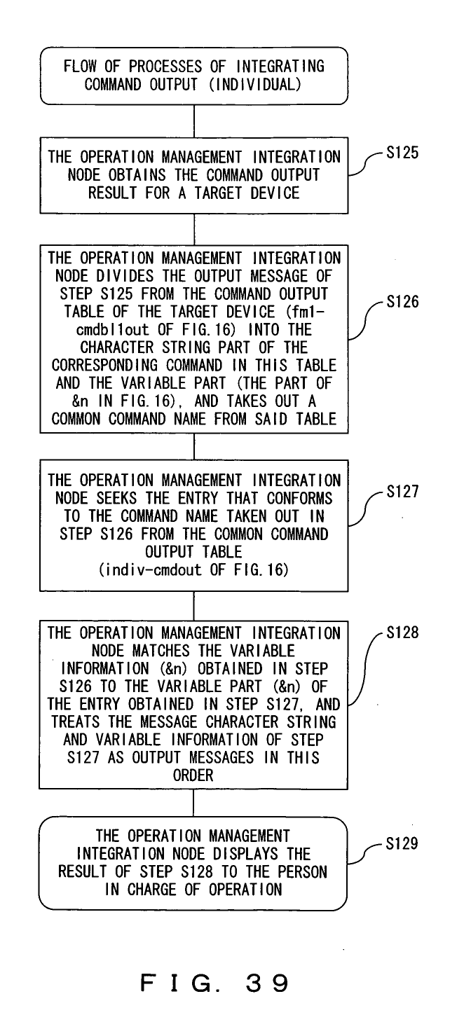

In Step S100 of FIG. 37, when an operation command is inputted from the person in charge of operation, in Step S101, the operation management integration node judges whether the inputted command is for a specific interface or not. If the judgement in Step S101 is NO, in Step S108, the operation management integration node proceeds to the flow shown in FIG. 38. If the judgement in Step S101 is YES, in Step S102, the operation management integration node converts the designated interface name for the virtual node into the target device and the interface name for the target device. In Step S103, the operation management integration node converts the inputted command for the virtual node into the command form for the target device using FIG. 22.In Step S103, the operation management integration node converts the inputted command for the virtual node into the command form for the target device using FIG. 15, and in Step S104, carries out the connection for the command operation of the target device. At that time, the operation management integration node uses the information shown in FIG. 9. In Step S105, the operation management integration node inputs a command in the command form obtained as the result of command conversion in Step S103, and in Step S06, converts the information obtained as the result of command input in Step S103 into the common command output form (refer to FIG. 39). In Step S107, the operation management integration node displays the result of Step S106 to the person in charge of operation.

In Step S110 of FIG. 38, the operation management integration node discriminates the functions that a command provides (using the function information shown in FIG. 14). In Step S111, the operation management integration node takes out one target device from the constituent device table (FIG. 8), and in Step S112, judges whether there is no target device. If the judgement in Step S112 is YES, the operation management integration node proceeds to S119. If the judgement in Step S112 is NO, in Step S113, the operation management integration node retrieves the target device of Step S111 from FIG. 10, and judges whether the function of Step S110 is included in the functions that the target device provides. If the judgement in Step S113 is NO, the operation management integration node proceeds to Step S119. If the judgement in Step S113 is YES, in Step S114, the operation management integration node converts the input command for the virtual node into the command form for the target device. At that time, the operation management integration node uses the information shown in FIG. 15. In Step S115, the operation management integration node executes connection to operate the command for the target device. At that time, the operation management integration node uses the information shown in FIG. 9. In Step S116, the operation management integration node inputs the command in the command form of Step S114. In Step S117, the operation management integration node converts the information obtained as the result of command execution in Step S116 into the common command output form (refer to FIG. 39). In Step S118, the operation management integration node accumulates the information of S117 in the temporary file, and returns to Step S111.

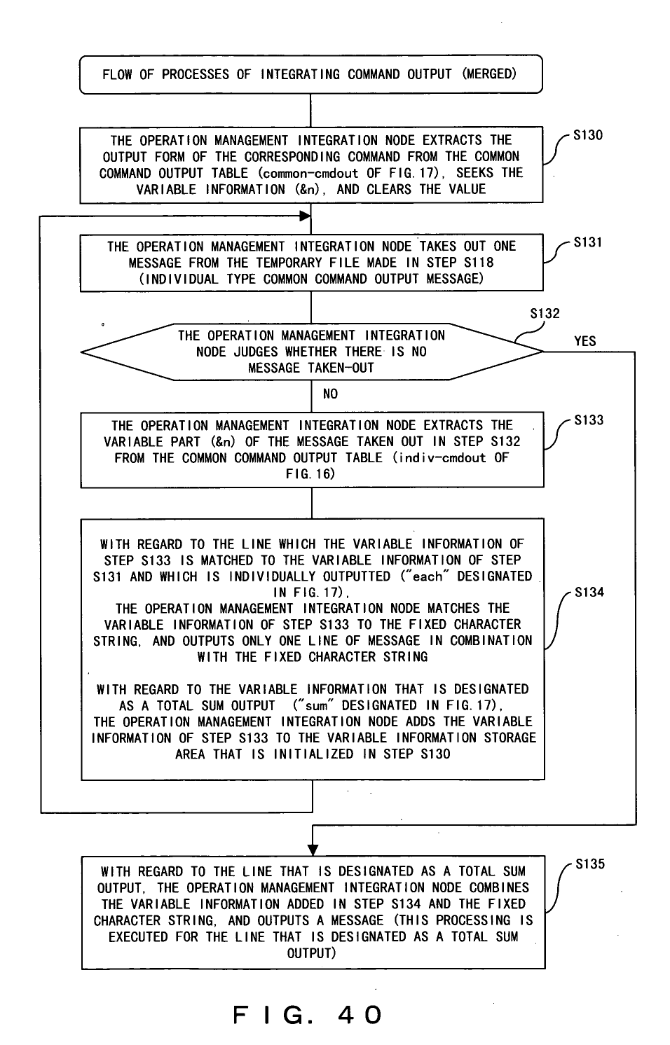

In Step S119, the operation management integration node merges the accumulated information of Step S118 as one piece of output information (refer to FIG. 40). Then, in Step S120, the operation management integration node displays the result of Step S119 to the person in charge of operation.

FIG. 39 and FIG. 40 are flowcharts showing the flow of the processes of converting a command output message from each device into the common output message form for the virtual node. First, in Step S125 of FIG. 39, the operation management integration node obtains the command output result for a target device. In Step S126, the operation management integration node divides the output message of Step S125 from the output table of the target device (fm1-cmdbl1out of FIG. 16) into the character string of the corresponding command in this table and the variable part (the part of &n in FIG. 16), and takes out a common command name from said table. In Step S127, the operation management integration node seeks the entry that conforms to the command name taken out in Step S126 from the common command output table (indiv-cmdout of FIG. 16). In Step S128, the operation management integration node matches the variable information (&n) obtained in Step S126 to the variable part (&n) of the entry obtained in Step S127, and treats the message character string and variable information of Step S127 as output messages in this order. In Step S129, the operation management integration node displays the result of Step S128 to the person in charge of operation.

In Step S130 of FIG. 40, the operation management integration node extracts the output form of the corresponding command from the common command output table (for common use: common-cmdout of FIG. 17), seeks the variable information (&n), and clears the value. In Step S131, the operation management integration node takes out one message from the temporary file made in Step S118 of FIG. 38 (individual type common command output message). In Step s132, the operation management integration node judges whether there is no taken-out message. If the judgement in Step S132 is YES, the operation management integration node proceeds to step S135. If the judgement in Step S132 is NO, in Step S133, the operation management integration node extracts the variable part ((&n) of the message taken out in Step S132 from the common command output table (indiv-cmdout of FIG. 16)). In Step S134, with regard to the line in which the variable information of Step S133 is matched to the variable information of Step S131 and which is individually outputted (“each” designated in FIG. 17), the operation management integration node matches the variable information of step S133 to the fixed character string, and outputs only one line of message in combination with the fixed character string. With regard to the variable information that is designated as a total sum output (“sum” designated in FIG. 17), the operation management integration node adds the variable information of Step S133 to the variable information storage area that is initialized in Step S130.

In Step s135, with regard to the line that is designated as a total sum output (“sum” is designated in FIG. 16), the operation management integration node combines the variable information added in Step S134 and the fixed character string, and outputs a message (this processing is executed for the line that is designated as a total sum output).

According to the embodiment of the present invention, the following effects can be expected.
(1) It is possible to virtualize a plurality of network devices having different functions in one system and manage the system. Thus, the devices that should be directly operated are put together into one system, and the person in charge of operation does not need to access each device to operate it.
(2) All that the person in charge of operation has to do is to be conscious of the interface of one virtual node without having to be conscious of the interface of each device.
(3) The person in charge of operation does not need to be conscious of the method of setting definitions for each device, and a definition file does not need to be retained for each device.
(4) The person in charge of operation is able to operate all the devices only with the operation functions of the virtual node without having to be conscious of operation functions of each device.
(5) Each time the person in charge of operation instructs the change of a configuration definition and the reflection of the changed definition to the virtual node, the consistency of each function among the devices constituting the virtual node is automatically confirmed, thus relieving the person in charge of operation from the works required for recognizing the functions that each device has and for confirming the consistency of functions among the devices.

1. A management system that unitarily controls a plurality of devices connected to a network, comprising:
a communication unit communicating with each device; and
an operation management integration unit having each device as an internal structure, having a virtual node having one command format, automatically converting the control contents designated to the virtual node by one command format into the format for each device, and issuing the control contents to each device via the communication unit.

2. The management system according to claim 1, wherein
the virtual node has a virtual interface that corresponds to the interface that each device has, enables a person in charge of operation to perform control using the virtual interface, converts the control contents based on the virtual interface into the control contents for the interface that each device has, and instructs the control contents to each device.

3. The management system according to claim 1, wherein
the operation management integration unit checks the consistency among the devices of the information set for each device, and gives a warning to the person in charge of operation if the information set for each device is not consistent.

4. The management system according to claim 1, wherein
said each device includes a plurality of devices having different functions such as a router, switch, firewall, load sharing device, and server.

5. The management system according to claim 1, wherein
the operation management integration unit has a unit that obtains from each device information about an operation state of each device; and
the operation management integration unit converts the information in the format peculiar to each device which is obtained from each device into the information in a unified format that the virtual node has, and then provides the information to the person in charge of operation.

6. A management method that unitarily controls a plurality of devices connected to a network, comprising:
communicating with each device is provided;
providing each device as an internal structure;
proviging a virtual node having one command format;
automatically converting the control contents designated to the virtual node by one command format into the format for each device; and
issuing the control contents to each device via the communication unit.

7. The management method according to claim 6, wherein
the virtual node has a virtual interface that corresponds to the interface that each device has, enables a person in charge of operation to perform control using the virtual interface, converts the control contents based on the virtual interface into the control contents for the interface that each device has, and instructs the control contents to each device.

8. A program that directs a computer to realize a management method which controls a plurality of devices connected to a network comprising:
communicating with each device is provided;
providing each device as an internal structure;
providing a virtual node having one command format;
automatically converting the control contents designated to the virtual node by one command format into the format for each device; and
issuing the control contents to each device via the communication unit.

9. The program according to claim 8, wherein
the virtual node has a virtual interface that corresponds to the interface that each device has, enables a person in charge of operation to perform control using the virtual interface, converts the control contents based on the virtual interface into the control contents for the interface that each device has, and instructs the control contents to each device.
